(19) United States
(12) Patent Application Publication
(10) Pub. No.: US 2025/0193879 A1
(43) Pub. Date: Jun. 12, 2025

(54) TRANSMISSIONS USING OVERLAPPING PHYSICAL UPLINK CONTROL CHANNELS AND PHYSICAL UPLINK SHARED CHANNELS

(71) Applicant: QUALCOMM Incorporated, San Diego, CA (US)

(72) Inventors: Mostafa KHOSHNEVISAN, San Diego, CA (US); Shaozhen GUO, Beijing (CN); Jing SUN, San Diego, CA (US); Xiaoxia ZHANG, San Diego, CA (US)

(21) Appl. No.: 18/842,262

(22) PCT Filed: Apr. 28, 2022
(86) PCT No.: PCT/CN2022/089842

§ 371 Date: Aug. 28, 2024

(51) Int. Cl. H04W 72/1268; H04L 5/00; H04W 72/0446

(52) U.S. Cl. CPC H04W 72/1268; H04L 5/0055; H04W 72/0446

(57) ABSTRACT

Various aspects of the present disclosure generally relate to wireless communication. In some aspects, a user equipment (UE) may determine that a first physical uplink control channel (PUCCH) at least partially overlaps with a second PUCCH, and that the first PUCCH and the second PUCCH can be simultaneously transmitted. The UE may also determine that at least one of the first PUCCH or the second PUCCH at least partially overlaps with one or more physical uplink shared channels (PUSCHs). The UE may transmit communications using less than all of the first PUCCH, the second PUCCH, and the one or more PUSCHs based at least in part on at least one of multiplexing uplink control information with at least one PUSCH, or dropping communications associated with at least one of the first PUCCH, the second PUCCH, or the one or more PUSCHs. Numerous other aspects are described.

### FIELD OF THE DISCLOSURE

Aspects of the present disclosure generally relate to wireless communication and to techniques and apparatuses for transmissions for overlapping physical uplink control channels and physical uplink shared channels.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of an open radio access network architecture, in accordance with the present disclosure.

FIG. 4 is a diagram illustrating an example of physical channels and reference signals in a wireless network, in accordance with the present disclosure.

FIG. 5 is a diagram illustrating an example of uplink control information multiplexing, in accordance with the present disclosure.

FIG. 6 is a diagram illustrating an example of transmission reception point differentiation at a UE based at least in part on a control resource set pool index, in accordance with the present disclosure.

FIGS. 7-12 are diagrams illustrating examples of transmissions using overlapping physical uplink control channels and physical uplink shared channels, in accordance with the present disclosure.

FIG. 13 is a diagram illustrating an example process performed, for example, by a UE, in accordance with the present disclosure.

FIG. 14 is a diagram illustrating an example process performed, for example, by a network entity, in accordance with the present disclosure.

FIGS. 15-16 are diagrams of example apparatuses for wireless communication, in accordance with the present disclosure.

### SUMMARY

Some aspects described herein relate to a method of wireless communication performed by a user equipment (UE). The method may include determining that a first physical uplink control channel (PUCCH) at least partially overlaps, in a time domain, with a second PUCCH, and that the first PUCCH and the second PUCCH can be simultaneously transmitted, wherein the first PUCCH includes a first uplink control information (UCI) associated with a first control resource set (CORESET) pool index, the second PUCCH includes a second UCI associated with a second CORESET pool index, and the first PUCCH and the second PUCCH are determined after performing UCI multiplexing procedures for overlapping PUCCHs. The method may include determining that at least one of the first PUCCH or the second PUCCH at least partially overlaps, in the time domain, with one or more physical uplink shared channels (PUSCHs). The method may include transmitting communications using less than all of the first PUCCH, the second PUCCH, and the one or more PUSCHs based at least in part on at least one of multiplexing at least one of the first UCI or the second UCI with at least one PUSCH, of the one or more PUSCHs, or dropping communications associated with at least one of the first PUCCH, the second PUCCH, or the one or more PUSCHs.

Some aspects described herein relate to a method of wireless communication performed by a network entity. The method may include determining that a first PUCCH associated with a UE at least partially overlaps, in a time domain, with a second PUCCH, and that the UE is capable of simultaneous transmission of the first PUCCH and the second PUCCH, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs. The method may include determining that at least one of the first PUCCH or the second PUCCH at least partially overlaps, in the time domain, with one or more PUSCHs. The method may include receiving, from the UE, a communication based at least in part on the determination, wherein the communication includes at least one of the first UCI or the second UCI multiplexed with at least one PUSCH, of the one or more PUSCHs.

Some aspects described herein relate to an apparatus for wireless communication at a UE. The apparatus may include a memory and one or more processors coupled to the memory. The one or more processors may be configured to determine that a first PUCCH at least partially overlaps, in a time domain, with a second PUCCH, and that the first PUCCH and the second PUCCH can be simultaneously transmitted, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs. The one or more processors may be configured to determine that at least one of the first PUCCH or the second PUCCH at least partially overlaps, in the time domain, with one or more PUSCHs. The one or more processors may be configured to transmit communications using less than all of the first PUCCH, the second PUCCH, and the one or more PUSCHs based at least in part on at least one of multiplexing at least one of the first UCI or the second UCI with at least one PUSCH, of the one or more PUSCHs, or dropping communications associated with at least one of the first PUCCH, the second PUCCH, or the one or more PUSCHs.

Some aspects described herein relate to an apparatus for wireless communication at a network entity. The network entity may include a memory and one or more processors coupled to the memory. The one or more processors may be configured to determine that a first PUCCH associated with a UE at least partially overlaps, in a time domain, with a second PUCCH, and that the UE is capable of simultaneous transmission of the first PUCCH and the second PUCCH, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs. The one or more processors may be configured to determine that at least one of the first PUCCH or the second PUCCH at least partially overlaps, in the time domain, with one or more PUSCHs. The one or more processors may be configured to receive, from the UE, a communication based at least in part on the determination, wherein the communication includes at least one of the first UCI or the second UCI multiplexed with at least one PUSCH, of the one or more PUSCHs.

Some aspects described herein relate to a non-transitory computer-readable medium that stores a set of instructions for wireless communication by a UE. The set of instructions, when executed by one or more processors of the UE, may cause the UE to determine that a first PUCCH at least partially overlaps, in a time domain, with a second PUCCH, and that the first PUCCH and the second PUCCH can be simultaneously transmitted, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs. The set of instructions, when executed by one or more processors of the UE, may cause the UE to determine that at least one of the first PUCCH or the second PUCCH at least partially overlaps, in the time domain, with one or more PUSCHs. The set of instructions, when executed by one or more processors of the UE, may cause the UE to transmit communications using less than all of the first PUCCH, the second PUCCH, and the one or more PUSCHs based at least in part on at least one of multiplexing at least one of the first UCI or the second UCI with at least one PUSCH, of the one or more PUSCHs, or dropping communications associated with at least one of the first PUCCH, the second PUCCH, or the one or more PUSCHs.

Some aspects described herein relate to a non-transitory computer-readable medium that stores a set of instructions for wireless communication by a network entity. The set of instructions, when executed by one or more processors of the network entity, may cause the network entity to determine that a first PUCCH associated with a UE at least partially overlaps, in a time domain, with a second PUCCH, and that the UE is capable of simultaneous transmission of the first PUCCH and the second PUCCH, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs. The set of instructions, when executed by one or more processors of the network entity, may cause the network entity to determine that at least one of the first PUCCH or the second PUCCH at least partially overlaps, in the time domain, with one or more PUSCHs. The set of instructions, when executed by one or more processors of the network entity, may cause the network entity to receive, from the UE, a communication based at least in part on the determination, wherein the communication includes at least one of the first UCI or the second UCI multiplexed with at least one PUSCH, of the one or more PUSCHs.

Some aspects described herein relate to an apparatus for wireless communication. The apparatus may include means for determining that a first PUCCH at least partially overlaps, in a time domain, with a second PUCCH, and that the first PUCCH and the second PUCCH can be simultaneously transmitted, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs. The apparatus may include means for determining that at least one of the first PUCCH or the second PUCCH at least partially overlaps, in the time domain, with one or more PUSCHs. The apparatus may include means for transmitting communications using less than all of the first PUCCH, the second PUCCH, and the one or more PUSCHs based at least in part on at least one of multiplexing at least one of the first UCI or the second UCI with at least one PUSCH, of the one or more PUSCHs, or dropping communications associated with at least one of the first PUCCH, the second PUCCH, or the one or more PUSCHs.

Some aspects described herein relate to an apparatus for wireless communication. The apparatus may include means for determining that a first PUCCH associated with a UE at least partially overlaps, in a time domain, with a second PUCCH, and that the UE is capable of simultaneous transmission of the first PUCCH and the second PUCCH, wherein, the first PUCCH includes a first UCI associated with a first CORESET pool index, the second PUCCH includes a second UCI associated with a second CORESET pool index, and the first PUCCH and the second PUCCH are determined after considering UCI multiplexing procedures for overlapping PUCCHs. The apparatus may include means for determining that at least one of the first PUCCH or the second PUCCH at least partially overlaps, in the time domain, with one or more PUSCHs. The apparatus may include means for receiving, from the UE, a communication based at least in part on the determination, wherein the communication includes at least one of the first UCI or the second UCI multiplexed with at least one PUSCH, of the one or more PUSCHs.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

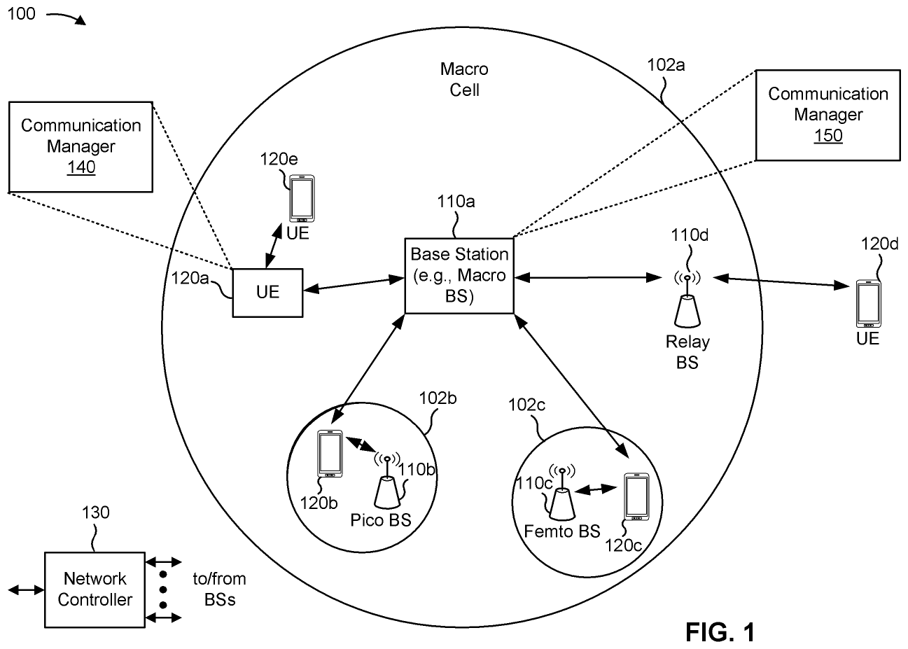

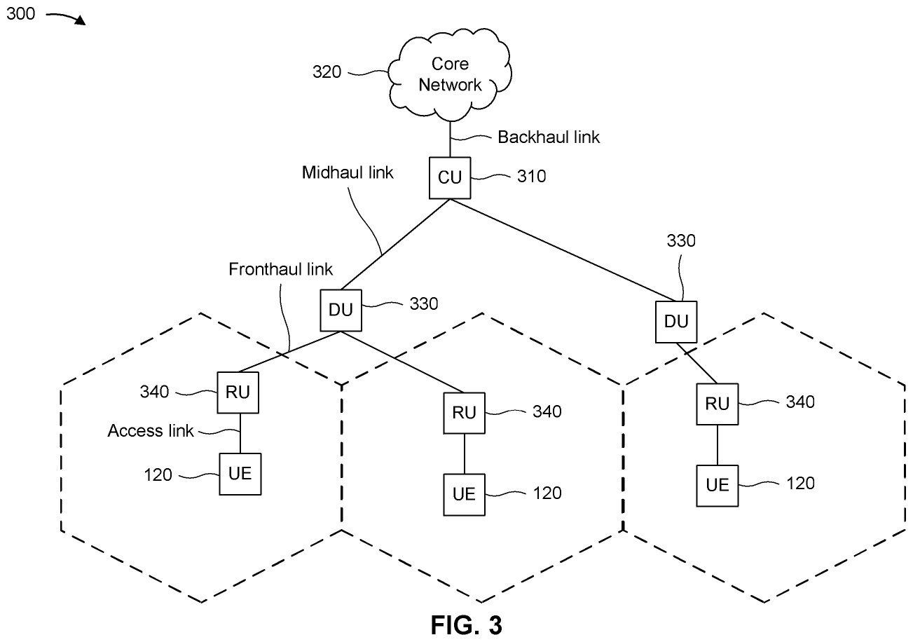

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although the base station 110 is shown as an integral unit in FIG. 1, aspects of the disclosure are not so limited. In some aspects, the functionality of the base station 110 may be disaggregated according to an open radio access network (O-RAN) architecture or the like, which is described in more detail in connection with FIG. 3. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may determine that a first physical uplink control channel (PUCCH) at least partially overlaps, in a time domain, with a second PUCCH, and that the first PUCCH and the second PUCCH can be simultaneously transmitted, wherein the first PUCCH includes a first uplink control information (UCI) associated with a first control resource set (CORESET) pool index, the second PUCCH includes a second UCI associated with a second CORESET pool index, and the first PUCCH and the second PUCCH are determined after performing UCI multiplexing procedures for overlapping PUCCHs; determine that at least one of the first PUCCH or the second PUCCH at least partially overlaps, in the time domain, with one or more physical uplink shared channels (PUSCHs); and transmit communications using less than all of the first PUCCH, the second PUCCH, and the one or more PUSCHs based at least in part on at least one of: multiplexing at least one of the first UCI or the second UCI with at least one PUSCH, of the one or more PUSCHs, or dropping communications associated with at least one of the first PUCCH, the second PUCCH, or the one or more PUSCHs. Additionally, or alternatively, the communication manager 140 may perform one or more other operations described herein.

In some aspects, the network entity described elsewhere herein may correspond to the base station 110 or may be associated with the base station 110. The network entity may include a communication manager 150. As described in more detail elsewhere herein, the communication manager 150 may determine that a first PUCCH associated with a UE at least partially overlaps, in a time domain, with a second PUCCH, and that the UE is capable of simultaneous transmission of the first PUCCH and the second PUCCH, wherein the first PUCCH includes a first UCI associated with a first CORESET pool index, the second PUCCH includes a second UCI associated with a second CORESET pool index, and the first PUCCH and the second PUCCH are determined after considering UCI multiplexing procedures for overlapping PUCCHs; determine that at least one of the first PUCCH or the second PUCCH at least partially overlaps, in the time domain, with one or more PUSCHs; and receive, from the UE, a communication based at least in part on the determination, wherein the communication includes at least one of the first UCI or the second UCI multiplexed with at least one PUSCH, of the one or more PUSCHs. Additionally, or alternatively, the communication manager 150 may perform one or more other operations described herein.

As indicated above, FIG. 1 is provided as an example. Other examples may differ from what is described with regard to FIG. 1.

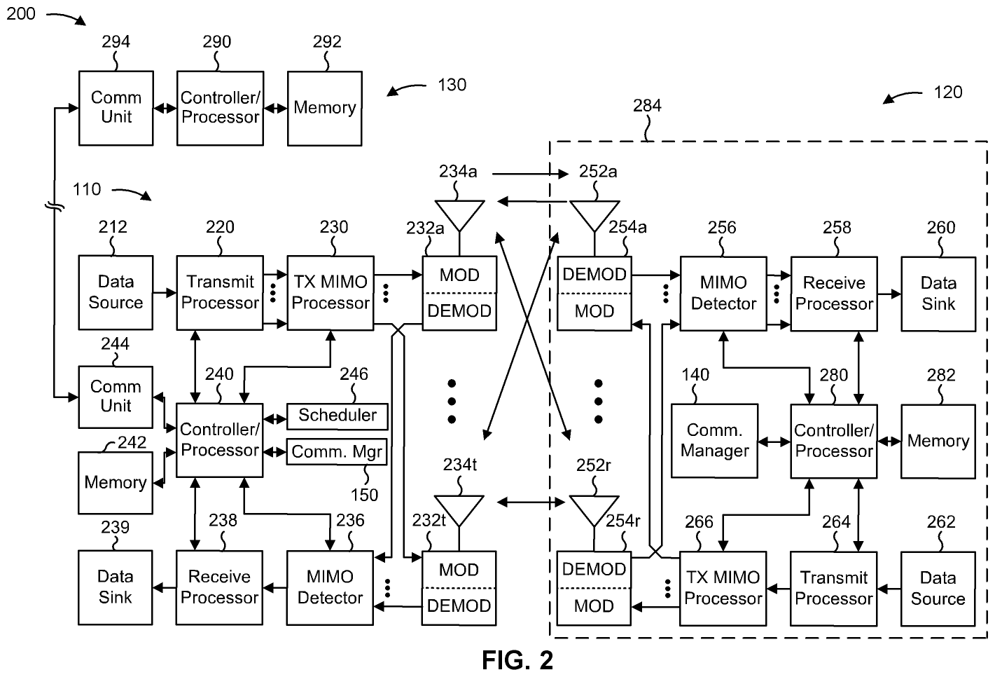

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

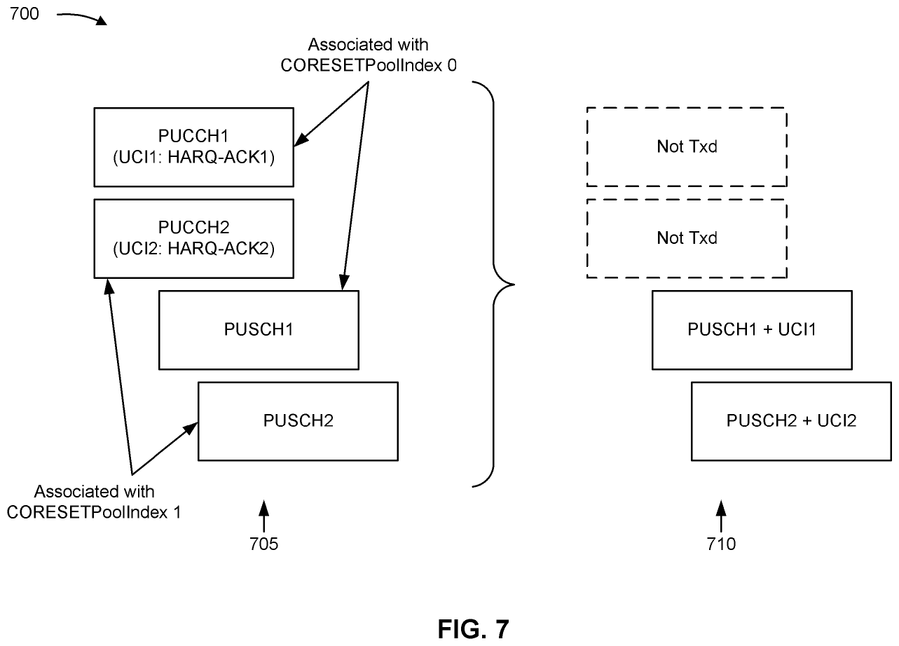

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-16).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-16).

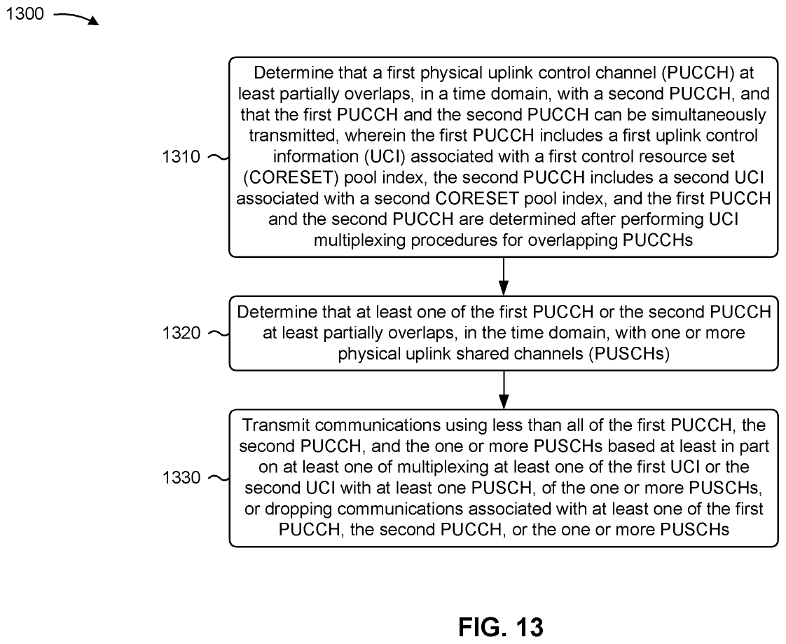

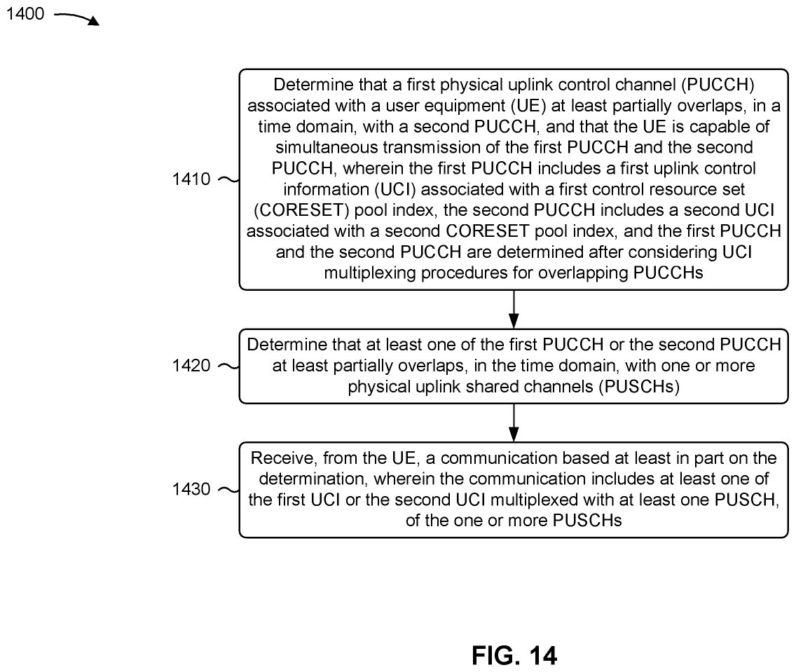

The controller/processor 240 of the base station 110, the controller/processor 280 of the UE 120, and/or any other component(s) of FIG. 2 may perform one or more techniques associated with transmissions using overlapping PUCCHs and PUSCHs, as described in more detail elsewhere herein. In some aspects, the network entity described herein is the base station 110, is included in the base station 110, or includes one or more components of the base station 110 shown in FIG. 2. The controller/processor 240 of the base station 110, the controller/processor 280 of the UE 120, and/or any other component(s) of FIG. 2 may perform or direct operations of, for example, process 1300 of FIG. 13, process 1400 of FIG. 14, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1300 of FIG. 13, process 1400 of FIG. 14, and/or other processes as described herein. In some examples, executing instructions may include running the instructions, converting the instructions, compiling the instructions, and/or interpreting the instructions, among other examples.

In some aspects, the UE 120 includes means for determining that a first PUCCH at least partially overlaps, in a time domain, with a second PUCCH, and that the first PUCCH and the second PUCCH can be simultaneously transmitted, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs; and/or means for determining that at least one of the first PUCCH or the second PUCCH at least partially overlaps, in the time domain, with one or more PUSCHs; and/or means for transmitting communications using less than all of the first PUCCH, the second PUCCH, and the one or more PUSCHs based at least in part on at least one of: means for multiplexing at least one of the first UCI or the second UCI with at least one PUSCH, of the one or more PUSCHs, or means for dropping communications associated with at least one of the first PUCCH, the second PUCCH, or the one or more PUSCHs. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity described elsewhere herein includes means for determining that a first PUCCH associated with a UE at least partially overlaps, in a time domain, with a second PUCCH, and that the UE is capable of simultaneous transmission of the first PUCCH and the second PUCCH, wherein the first PUCCH includes a first UCI associated with a first CORESET pool index, the second PUCCH includes a second UCI associated with a second CORESET pool index, and the first PUCCH and the second PUCCH are determined after considering UCI multiplexing procedures for overlapping PUCCHs; and/or means for determining that at least one of the first PUCCH or the second PUCCH at least partially overlaps, in the time domain, with one or more PUSCHs; and/or means for receiving, from the UE, a communication based at least in part on the determination, wherein the communication includes at least one of the first UCI or the second UCI multiplexed with at least one PUSCH, of the one or more PUSCHs. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of an O-RAN architecture, in accordance with the present disclosure. As shown in FIG. 3, the O-RAN architecture may include a centralized unit (CU) 310 that communicates with a core network 320 via a backhaul link. Furthermore, the CU 310 may communicate with one or more distributed units (DUs) 330 via respective midhaul links. The DUs 330 may each communicate with one or more radio units (RUs) 340 via respective fronthaul links, and the RUs 340 may each communicate with respective UEs 120 via radio frequency (RF) access links. The DUs 330 and the RUs 340 may also be referred to as O-RAN DUS (O-DUs) 330 and O-RAN RUs (O-RUs) 340, respectively.

In some aspects, the DUs 330 and the RUs 340 may be implemented according to a functional split architecture in which functionality of a base station 110 (e.g., an eNB or a gNB) is provided by a DU 330 and one or more RUs 340 that communicate over a fronthaul link. Accordingly, as described herein, a base station 110 may include a DU 330 and one or more RUs 340 that may be co-located or geographically distributed. In some aspects, the DU 330 and the associated RU(s) 340 may communicate via a fronthaul link to exchange real-time control plane information via a lower layer split (LLS) control plane (LLS-C) interface, to exchange non-real-time management information via an LLS management plane (LLS-M) interface, and/or to exchange user plane information via an LLS user plane (LLS-U) interface.

Accordingly, the DU 330 may correspond to a logical unit that includes one or more base station functions to control the operation of one or more RUs 340. For example, in some aspects, the DU 330 may host a radio link control (RLC) layer, a medium access control (MAC) layer, and one or more high physical (PHY) layers (e.g., forward error correction (FEC) encoding and decoding, scrambling, and/or modulation and demodulation) based at least in part on a lower layer functional split. Higher layer control functions, such as a packet data convergence protocol (PDCP), radio resource control (RRC), and/or service data adaptation protocol (SDAP), may be hosted by the CU 310. The RU(s) 340 controlled by a DU 330 may correspond to logical nodes that host RF processing functions and low-PHY layer functions (e.g., fast Fourier transform (FFT), inverse FFT (iFFT), digital beamforming, and/or physical random access channel (PRACH) extraction and filtering) based at least in part on the lower layer functional split. Accordingly, in an O-RAN architecture, the RU(s) 340 handle all over the air (OTA) communication with a UE 120, and real-time and non-real-time aspects of control and user plane communication with the RU(s) 340 are controlled by the corresponding DU 330, which enables the DU(s) 330 and the CU 310 to be implemented in a cloud-based RAN architecture.

As indicated above, FIG. 3 is provided as an example. Other examples may differ from what is described with regard to FIG. 3.

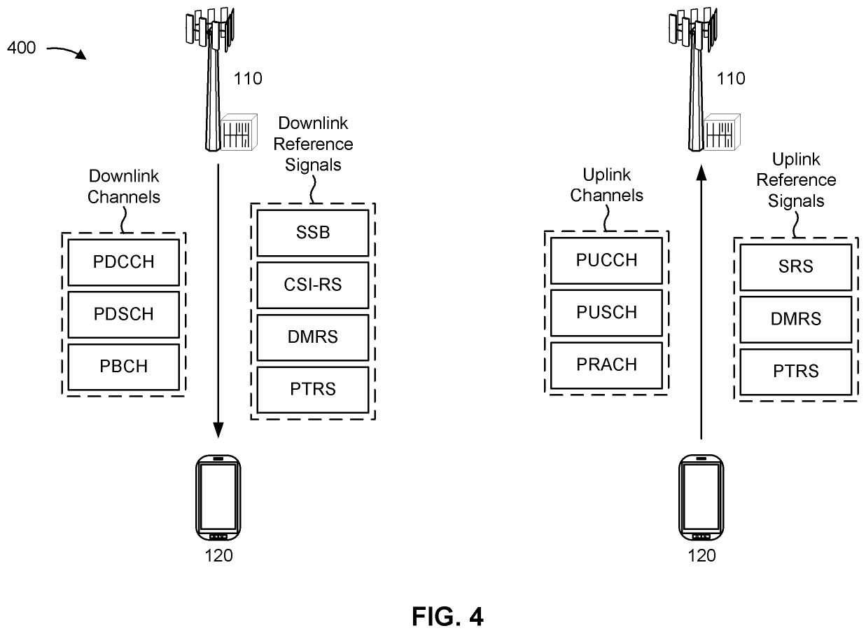

FIG. 4 is a diagram illustrating an example 400 of physical channels and reference signals in a wireless network, in accordance with the present disclosure. As shown in FIG. 4, downlink channels and downlink reference signals may carry information from a base station 110 to a UE 120, and uplink channels and uplink reference signals may carry information from a UE 120 to a base station 110.

As shown, a downlink channel may include a physical downlink control channel (PDCCH) that carries downlink control information (DCI), a physical downlink shared channel (PDSCH) that carries downlink data, or a physical broadcast channel (PBCH) that carries system information, among other examples. In some aspects, PDSCH communications may be scheduled by PDCCH communications. As further shown, an uplink channel may include a PUCCH that carries UCI, a PUSCH that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH. Moreover, in some aspects, the UE 120 may transmit channel state information (CSI), such as a CSI report, and/or a scheduling request (SR) in UCI on the PUCCH and/or the PUSCH.

As further shown, a downlink reference signal may include a synchronization signal block (SSB), a CSI reference signal (CSI-RS), a DMRS, a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the base station 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The base station 110 may configure a set of CSI-RSs for the UE 120, and the UE 120 may measure the configured set of CSI-RSs. Based at least in part on the measurements, the UE 120 may perform channel estimation and may report channel estimation parameters to the base station 110 (e.g., in a CSI report), such as a CQI, a precoding matrix indicator (PMI), a CSI-RS resource indicator (CRI), a layer indicator (LI), a rank indicator (RI), or an RSRP, among other examples. The base station 110 may use the CSI report to select transmission parameters for downlink communications to the UE 120, such as a number of transmission layers (e.g., a rank), a precoding matrix (e.g., a precoder), an MCS, or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the base station 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring base stations in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the base station 110 may then calculate a position of the UE 120 based on the RSTD measurements reported by the UE 120.

An SRS may carry information used for uplink channel estimation, which may be used for scheduling, link adaptation, precoder selection, or beam management, among other examples. The base station 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The base station 110 may measure the SRSs, may perform channel estimation based at least in part on the measurements, and may use the SRS measurements to configure communications with the UE 120.

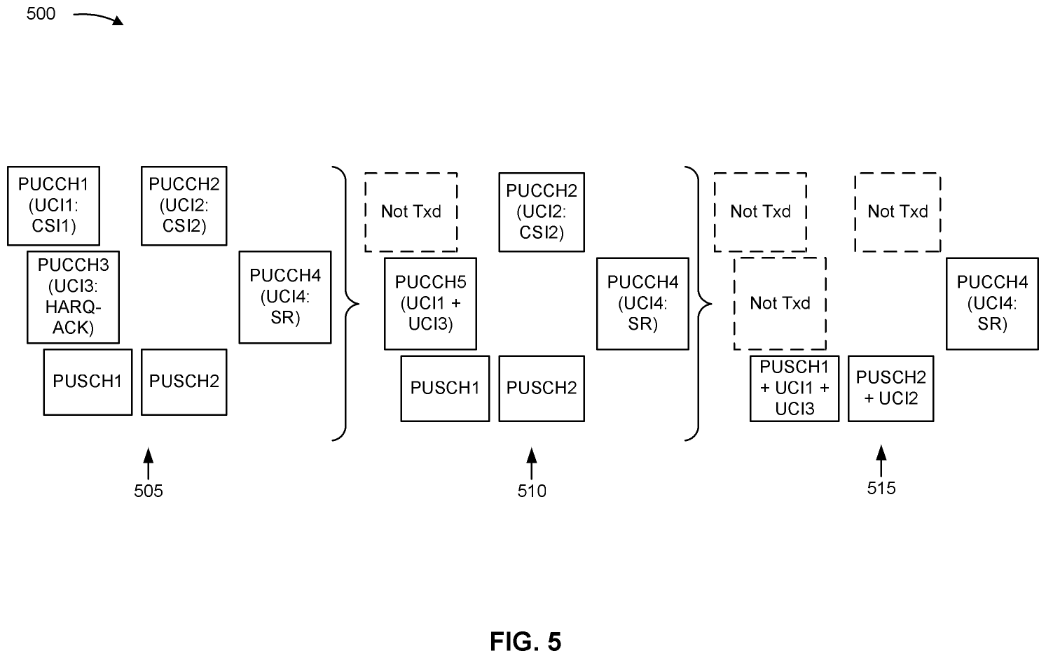

In some aspects, one or more channels and/or one or more transmissions in the downlink or the uplink may overlap with one another. If the base station 110 or the UE 120 is unable to simultaneously transmit the one or more channels and/or one or more transmissions, the corresponding entity may either multiplex communications into a single channel or else resolve which transmissions should be communicated and which should be dropped. Aspects of overlapping channels and transmissions are described in more detail in connection with FIG. 5.

As indicated above, FIG. 4 is provided as an example. Other examples may differ from what is described with regard to FIG. 4.

FIG. 5 is a diagram illustrating an example 500 of UCI multiplexing, in accordance with the present disclosure.

In the example depicted in FIG. 5, multiple PUCCHs and PUSCHs are scheduled for use by a UE (e.g., UE 120), with at least some time-domain overlapping PUCCHs and PUSCHs. For example, as indicated at reference number 505, a UE 120 may be scheduled with four PUCCHs (indexed in the example as PUCCH1, PUCCH2, PUCCH3, and PUCCH4) and two PUSCHs (indexed in the example as PUSCH1 and PUSCH2). Each of the PUCCHs may be scheduled to carry UCI, such as hybrid automatic repeat request (HARQ) feedback (e.g., HARQ-ACK or HARQ-NACK), CSI (e.g., a CSI report), and/or an SR. More particularly, in the depicted example, PUCCH1 is scheduled to carry a first UCI (indexed as UCI1) that includes a first CSI (indexed as CSI1), PUCCH2 is scheduled to carry a second UCI (indexed as UCI2) that includes a second CSI (indexed as CSI2), PUCCH3 is scheduled to carry a third UCI (indexed as UCI3) that includes an HARQ-ACK feedback, and PUCCH4 is scheduled to carry a fourth UCI (indexed as UCI4) that includes an SR.

As shown, some of the channels overlap with other channels. More particularly, PUCCH1 and PUCCH2 partially overlap with one another and further partially overlap with PUSCH1, PUCCH2 partially overlaps with PUSCH2, and PUCCH4 does not overlap with any other channels. In such aspects, the UE 120 may not be capable of simultaneously transmitting the overlapping channels, but may be capable of multiplexing the UCI in one or more PUCCHs and/or PUSCHs in order to transmit all scheduled communications. More particularly, the UE 120 may first resolve overlapping PUCCH resources for UCI multiplexing. For example, PUCCH1 at least partially overlaps with PUCCH3, and thus the UE 120 may be capable of multiplexing the associated UCI (e.g., UCI1 and UCI3, respectively) in a single PUCCH. Thus, as shown at reference number 510, UCI1 and UCI3 have been multiplexed into a fifth PUCCH, indexed as PUCCH5. PUCCH5 may be determined based at least in part on the total payload size of UCI1 and UCI3. And PUCCH 5 may be same or different PUCCH resource from one of the PUCCH 1 and PUCCH 3. More particularly, in the depicted example, PUCCH5 may be based at least in part on the resources associated with PUCCH3. Moreover, because UCI1 has been multiplexed in PUCCH5, the PUCCH originally scheduled to carry UCI1 (e.g., PUCCH1) may not be transmitted (as indicated by “Not Txd” in FIG. 5).

Once the UE 120 has resolved overlapping PUCCH resources for UCI multiplexing, the remaining PUCCHs with UCI will be non-overlapping, as shown by reference number 510. However, one or more PUCCHs may still overlap with one or more PUSCHs. More particularly, as shown at reference number 510, PUCCH5 (e.g., the PUCCH scheduled to carry UCI1 and UCI3) partially overlaps with PUSCH1, and PUCCH2 (e.g., the PUCCH scheduled to carry UCI2) partially overlaps with PUSCH2. In such cases, the UE 120 may multiplex UCIs from the partially overlapping PUCCHs in the corresponding PUSCHs, and thus not transmit the PUCCHs. More particularly, as shown by reference number 515, UCI1 and UCI3 may be multiplexed in PUSCH2, and UCI2 may be multiplexed in PUSCH2, and thus PUCCH5 and PUCCH2 are not transmitted. In some aspects, the UE 120 may be capable of multiplexing UCI associated with partially overlapping PUCCHs and PUSCHs (e.g., PUCCH5 and PUSCH2, or PUCCH2 and PUSCH2) both when the partially overlapping PUCCH and PUSCH are in the same component carrier, and when the partially overlapping PUCCH and PUSCH are in different component carriers. Moreover, in some aspects, a network entity may signal to the UE 120 certain parameters to enable multiplexing UCI in a PUSCH. For example, a beta offset signaled in an uplink grant (e.g., signaled in a DCI format 0_1 or 0_2 communication) and/or parameters configured via an RRC communication may be used to control rate matching behavior (e.g., may be used by the UE 120 to determine how to multiplex PUCCH on PUSCH, such as determining a number of resources that a UCI payload can occupy on a PUSCH, or the like). In some aspects, if at least one of the partially overlapping PUCCH or PUSCH is a dynamically scheduled channel (e.g., a channel scheduled by DCI), when multiplexing UCI in a PUCCH or PUSCH, the UE 120 may satisfy joint timeline rules specified in a wireless communication standard, such as the joint timeline rules specified in Section 9.2.5 of 3GPP Technical Specification 38.213. As a result, and as shown by reference number 515, the UE 120 may be left with no overlapping PUCCHs and PUSCHs, and thus may transmit the remaining channels accordingly (e.g., the UE 120 may transmit PUSCH1 including UCI1 and UCI3, may transmit PUSCH2 including UCI2, and may transmit PUCCH4 including UCI4).

In some other aspects, a UE 120 may be capable of certain simultaneous PUCCH and PUSCH transmissions. For example, a UE 120 may be capable of simultaneous PUCCH and PUSCH transmissions if the PUCCH and the PUSCH are on different cells in inter-band carrier aggregation, and the PUCCH and the PUSCH are associated with different physical layer priority values (e.g., one of the PUCCH and the PUSCH is associated with a high priority communication, and the other one of the PUCCH and the PUSCH is associated with a low priority communication). However, in such aspects, the UE 120 may not be capable of simultaneous transmission if the PUCCH and the PUSCH are on the same cell, if the PUCCH and the PUSCH are on different CCs in intra-band carrier aggregation (CA), or if the PUCCH and the PUSCH are on different CCs in inter-band CA but are associated with the same physical layer priority value. In aspects in which a PUSCH may be simultaneously transmitted with a PUCCH (e.g., when the PUCCH and the PUSCH are on different cells in inter-band carrier aggregation and are associated with different physical layer priority values), the PUSCH may be excluded from overlapping channels for UCI multiplexing and/or prioritization rules (such as the UCI multiplexing rules described above in connection with reference numbers 505, 510, and 515) and the PUSCH may not be constrained by intra-UE multiplexing timeline requirements.

As indicated above, FIG. 5 is provided as an example. Other examples may differ from what is described with regard to FIG. 5.

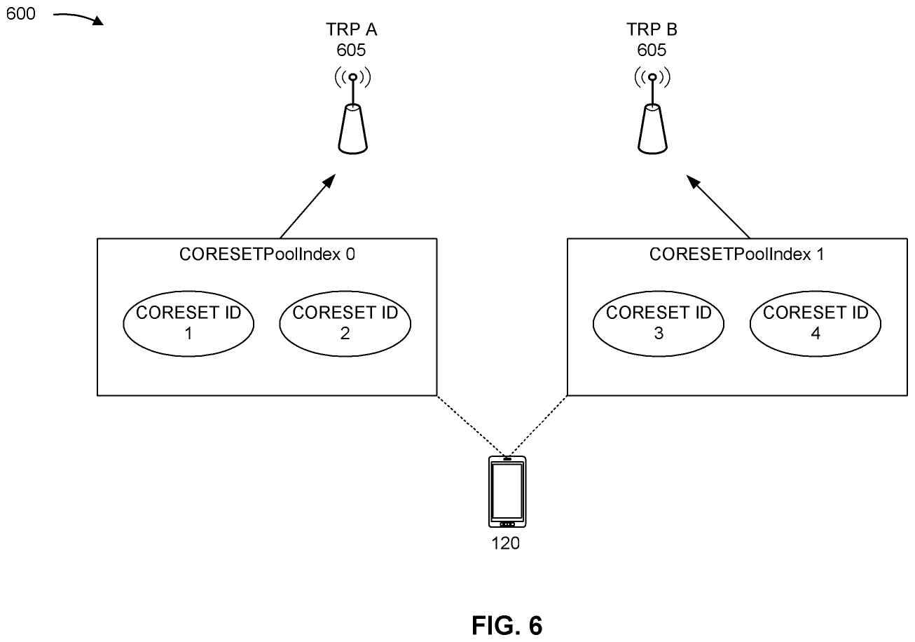

FIG. 6 is a diagram illustrating an example 600 of TRP differentiation at a UE based at least in part on a CORESET pool index, in accordance with the present disclosure. In some aspects, certain channels, such as the PUCCHs and PUSCHs described in connection with FIG. 5, may be associated with different TRPs. In some aspects, a CORESET pool index (or CORESETPoolIndex) value may be used by the UE 120 to identify a TRP associated with an uplink grant received on a PDCCH (e.g., to identify a TRP associated with a PUCCH and/or a PUSCH).

A CORESET may refer to a control region that is structured to support an efficient use of resources, such as by flexible configuration or reconfiguration of resources for one or more PDCCHs associated with a UE. In some aspects, a CORESET may occupy the first symbol of an OFDM slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As illustrated in FIG. 6, a UE 120 may be configured with multiple CORESETs in a given bandwidth part of a serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 6, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index may be associated with a particular TRP 605. As an example, and as illustrated in FIG. 6, a first TRP 605 (TRP A) may be associated with CORESET pool index 0 and a second TRP 605 (TRP B) may be associated with CORESET pool index 1. The UE 120 may be configured by a higher layer parameter, such as PDCCH-Config, with information identifying an association between a TRP and a CORESET pool index assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index associated with the CORESET pool in which the CORESET ID is included, and identifying the TRP associated with the CORESET pool index. In some aspects, a CORESET pool index of the CORESET in which a DCI is received may be used by the UE 120 for different purposes, such as for providing HARQ-ACK feedback.

In some aspects, a UE 120 may be configured to transmit simultaneous PUCCHs (e.g., at least partially overlapping PUCCHs) associated with DCIs received from different TRPs (e.g., DCIs associated with different CORESET pool indexes, sometimes referred to as a multi-DCI scenario). For example, a UE 120 may be capable of transmitting at least partially overlapping PUCCHs in one CC for purposes of providing separate HARQ feedback or the like. In such aspects, the UE 120 may be configured with a feedback mode parameter (sometimes referred to as ackNackFeedbackMode) indicating that the UE 120 may transmit at least partially overlapping PUCCHs for purposes of providing separate HARQ feedback (e.g., the UE 120 may be configured with ackNackFeedbackMode as “separate”). However, the UE 120 may be unable to transmit the overlapping PUCCHs simultaneously with a PUSCH.

For example, a UE 120 may be scheduled with two time-domain overlapping PUCCHs (e.g., PUCCH1 and PUCCH2) that can be simultaneously transmitted according to UCI multiplexing rules for overlapping PUCCH resources, such as the rules described above. For example, the UE 120 may be configured with a feedback mode parameter (e.g., ackNackFeedbackMode) indicating that PUCCH1 and PUCCH2 may be simultaneously transmitted for purposes of providing separate HARQ feedback, or the like. In such aspects, the PUCCHs may be associated with different TRPs, or CORESET pool indexes. For example, PUCCH1 may include a first HARQ feedback communication (e.g., HARQ-ACK1) and may be associated with a first CORESET pool index (e.g., CORESETPoolIndex 0), and PUCCH2 may include a second HARQ feedback communication (e.g., HARQ-ACK2) and may be associated with a second CORESET pool index (e.g., CORESETPoolIndex 1). Moreover, a PUSCH may at least partially overlap with both PUCCH1 and PUCCH2, and may be associated with a same CORESET pool index as PUCCH1 (e.g., CORESETPoolIndex 0). In such aspects, the UE 120 may multiplex UCI associated with PUCCH1 (e.g., HARQ-ACK1) on the PUSCH according to UCI multiplexing rules described above in connection with FIG. 5, because PUCCH1 and the PUSCH are associated with the same CORESET pool index. However, the UE 120 may drop UCI associated with PUCCH2 (e.g., HARQ-ACK2) because the UE 120 may not be capable of simultaneous PUCCH and PUSCH transmission unless the PUCCH and PUSCH meet certain conditions described above in connection with FIG. 5 (e.g., when the PUCCH and the PUSCH are on different cells in inter-band carrier aggregation and are associated with different physical layer priority values). This may be undesirable, because the UCI associated with PUCCH2 (e.g., HARQ-ACK2) may be more important than communications associated with the PUSCH. Accordingly, the UE 120 may drop certain high-priority communications (e.g., the UE 120 may drop PUCCH2 in the above example) and/or may delay transmission of certain high-priority communications (e.g., the UE 120 may delay transmission of communications associated with the overlapping PUCCHs or may delay communications associated with the PUSCH) when overlapping PUCCHs also overlap with a PUSCH. This may result in unreliable wireless communications, decreased throughput, increased latency, and overall inefficient usage of network resources.

Some techniques and apparatuses described herein enable enhanced transmission determinations when two or more time-domain overlapping PUCCHs overlap with one or more PUSCHs, thereby preserving high priority communications or the like. In some aspects, a UE (e.g., UE 120) may determine that two time-domain overlapping PUCCH resources can be simultaneously transmitted, with a first PUCCH, of the two time-domain overlapping PUCCH resources, including one or more UCIs (UCI1) associated with a first CORESET pool index, and with a second PUCCH, of the two time-domain overlapping PUCCH resources, including one or more UCIs associated with a second CORESET pool index. In some aspects, the first and the second PUCCH may be determined after applying UCI multiplexing procedures for overlapping PUCCHs. The UE may further determine that one or more PUSCHs overlap with at least one of the PUCCHs, and the UE may thus determine whether to multiplex UCI with one or more PUSCHs, or whether to drop the UCI or the one or more PUSCHs. As a result, the UE 120 may preserve certain high-priority communications when overlapping PUCCHs also overlap with a PUSCH, resulting in reliable wireless communications, increased throughput, decreased latency, and overall efficient usage of network resources.

As indicated above, FIG. 6 is provided as an example. Other examples may differ from what is described with respect to FIG. 6.

FIG. 7 is a diagram illustrating an example 700 of transmissions using overlapping PUCCHs and PUSCHs, in accordance with the present disclosure.

In the example shown in FIG. 7, a UE 120 may determine that two time-domain overlapping PUCCH resources (shown as PUCCH1 and PUCCH2 in FIG. 7) can be simultaneously transmitted in a CC or a cell, such as in a primary cell (PCell), a PUCCH secondary cell (PUCCH-SCell), or the like. For example, the UE 120 may determine that PUCCH1 and PUCCH2 can be simultaneously transmitted in a CC based at least in part on the rules described above in connection with FIGS. 5-6. More particularly, in some aspects, the UE 120 may determine that PUCCH1 and the PUCCH2 can be simultaneously transmitted in a CC based at least in part on the UE 120 being configured with a feedback mode parameter (e.g., ackNackFeedbackMode) indicating that the UE 120 may transmit at least partially overlapping PUCCHs for purposes of providing separate HARQ feedback. In that regard, PUCCH1 may be associated with UCI (shown as UCI1 in FIG. 7) including a first HARQ feedback communication (shown as HARQ-ACK1 in FIG. 7), and PUCCH2 may be associated with UCI (shown as UCI2 in FIG. 7) including a second HARQ feedback communication (shown as HARQ-ACK2 in FIG. 7). However, aspects of the disclosure are not so limited, and, in some other aspects, instead of, or in addition to, HARQ-ACK1, UCI1 may include CSI (e.g., a CSI report), an SR, or a combination thereof (e.g., HARQ-ACK1+CSI, or HARQ-ACK1+SR, or HARQ-ACK1+SR+CSI). Similarly, instead of, or in addition to, HARQ-ACK2, UCI2 may include CSI (e.g., a CSI report), an SR, or a combination thereof (e.g., HARQ-ACK2+CSI, or HARQ-ACK2+SR, or HARQ-ACK2+SR+CSI). And as described above in connection with FIG. 6, PUCCH1 and/or UCI1 may be associated with a first CORESET pool index (e.g., CORESETPoolIndex 0), and PUCCH2 and/or UCI2 may be associated with a second CORESET pool index (e.g., CORESETPoolIndex 1). In some aspects, PUCCH1 and PUCCH2 may be determined after UCI multiplexing procedures for overlapping PUCCHs, such as the UCI multiplexing procedures for overlapping PUCCHs described in connection with FIG. 5 or the like.

The UE 120 may also determine that one or more PUSCHs (which may be in the same CC as PUCCH1 and PUCCH2, or which may be in a different CC than PUCCH1 and PUCCH2) at least partially overlap with at least one of PUCCH1 or PUCCH2. For example, in FIG. 7 there are two PUSCHs, shown as PUSCH1 and PUSCH2. In this example, both PUSCHs at least partially overlap with at least one PUCCH. More particularly, as shown by reference number 705, both PUSCH1 and PUSCH2 at least partially overlap with both PUCCH1 and PUCCH2. Moreover, in this example, PUSCH1 may be associated with the first CORESET pool index (e.g., CORESETPoolIndex 0), and PUSCH2 may be associated with the second CORESET pool index (e.g., CORESETPoolIndex 1). Put another way, in the example shown in FIG. 7, there are one or more PUSCHs associated with CORESETPoolIndex 0 (e.g., PUSCH1) that overlap with PUCCH1, and one or more PUSCHs associated with CORESETPoolIndex 1 (e.g., PUSCH2) that overlap with PUCCH2.

In such aspects, and as shown by reference number 710, the UE 120 may multiplex UCI associated with PUCCH1 (e.g., UCI1) on PUSCH1, and thus may not transmit PUCCH1 (indicated using “Not Txd” in FIG. 7). In some aspects, when there are multiple PUSCHs associated with the first CORESET pool index (e.g., CORESETPoolIndex 0) that at least partially overlap with PUCCH1, the UE 120 may select one of the PUSCHs (e.g., PUSCH1) for multiplexing UCI1 based at least in part on a prioritization rule. In some aspects, the prioritization rule may result in the UE 120 first selecting a PUSCH that is associated with a lowest CC index, and then (if more than one PUSCH is associated with the lowest CC index) selecting a PUSCH associated with an earliest starting time. Similarly, the UE 120 may multiplex UCI associated with PUCCH2 (e.g., UCI2) on PUSCH2, and thus may not transmit PUCCH2. And, in a similar manner as described above, when there are multiple PUSCHs associated with the second CORESET pool index (e.g., CORESETPoolIndex 1) that at least partially overlap with PUCCH2, the UE 120 may select one of the PUSCHs (e.g., PUSCH2) for multiplexing UCI2 based at least in part on a prioritization rule, such as first selecting a PUSCH that is associated with a lowest CC index, and then (if more than one PUSCH is associated with the lowest CC index) selecting a PUSCH associated with an earliest starting time.

As indicated above, FIG. 7 is provided as an example. Other examples may differ from what is described with respect to FIG. 7.

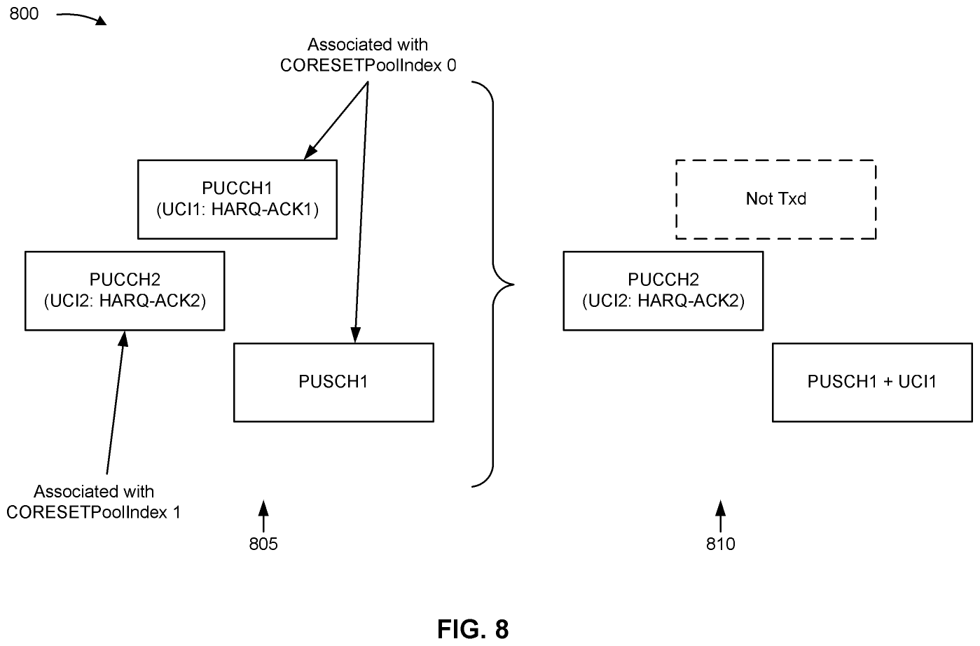

FIG. 8 is a diagram illustrating an example 800 of transmissions using overlapping PUCCHs and PUSCHs, in accordance with the present disclosure.

In the example depicted in FIG. 8, as shown by reference number 805, the UE 120 may determine that two time-domain overlapping PUCCH resources (shown as PUCCH1 and PUCCH2 in FIG. 8) can be simultaneously transmitted in a CC or a cell, in a similar manner as described above in connection with FIG. 7. In this aspect, however, the UE may determine that one or more PUSCHs (which may be in the same CC as PUCCH1 and PUCCH2, or which may be in a different CC than PUCCH1 and PUCCH2) associated with the first CORESET pool index (e.g., CORESETPoolIndex 0) at least partially overlap with PUCCH1, but that no PUSCHs associated with the first CORESET pool index (e.g., CORESETPoolIndex 0) overlap with PUCCH2, and that no PUSCHs associated with the second CORESET pool index (e.g., CORESETPoolIndex 1) overlap with PUCCH2. For example, in FIG. 8 there is one PUSCH, shown as PUSCH1, which is associated with the first CORESET pool index (e.g., CORESETPoolIndex 0), which at least partially overlaps with PUCCH1. However, there are no PUSCHs associated with the first CORESET pool index (e.g., CORESETPoolIndex 0) or the second CORESET pool index (e.g., CORESETPoolIndex 1) that overlap with PUSCH2.

In such aspects, and as shown by reference number 810, the UE 120 may multiplex UCI associated with PUCCH1 (e.g., UCI1) on PUSCH1, and thus may not transmit PUCCH1. In some aspects, when there are multiple PUSCHs associated with the first CORESET pool index (e.g., CORESETPoolIndex 0) that at least partially overlap with PUCCH1, the UE 120 may select one of the PUSCHs (e.g., PUSCH1) for multiplexing UCI1 based at least in part on a prioritization rule, as described. More particularly, in some aspects, the prioritization rule may result in the UE 120 first selecting a PUSCH that is associated with a lowest CC index, and then (if more than one PUSCH is associated with the lowest CC index) selecting a PUSCH associated with an earliest starting time. Moreover, because there are no PUSCHs overlapping PUCCH2, the UE 120 may transmit PUCCH2. More particularly, the UE 120 may transmit UCI associated with PUCCH2 (e.g., UCI2) on PUCCH2.

Although in the example described above in connection with FIG. 8, the PUSCH was described as being associated with the first CORESET pool index (e.g., CORESETPoolIndex 0) and at least partially overlapping with PUCCH1, in some other aspects, a PUSCH may be associated with the second CORESET pool index (e.g., CORESETPoolIndex 1) and the UE 120 may act in a similar manner as described above. For example, based at least in part on one or more PUSCHs being associated with the second CORESET pool index and overlapping with the PUCCH2, no PUSCHs associated with the first CORESET pool index overlapping PUCCH1, and no PUSCHs associated with the second CORESET pool index overlapping with PUCCH1, the UE 120 may multiplex UCI2 on the PUSCH and transmit UCI1 in the PUCCH1.

As indicated above, FIG. 8 is provided as an example. Other examples may differ from what is described with respect to FIG. 8.

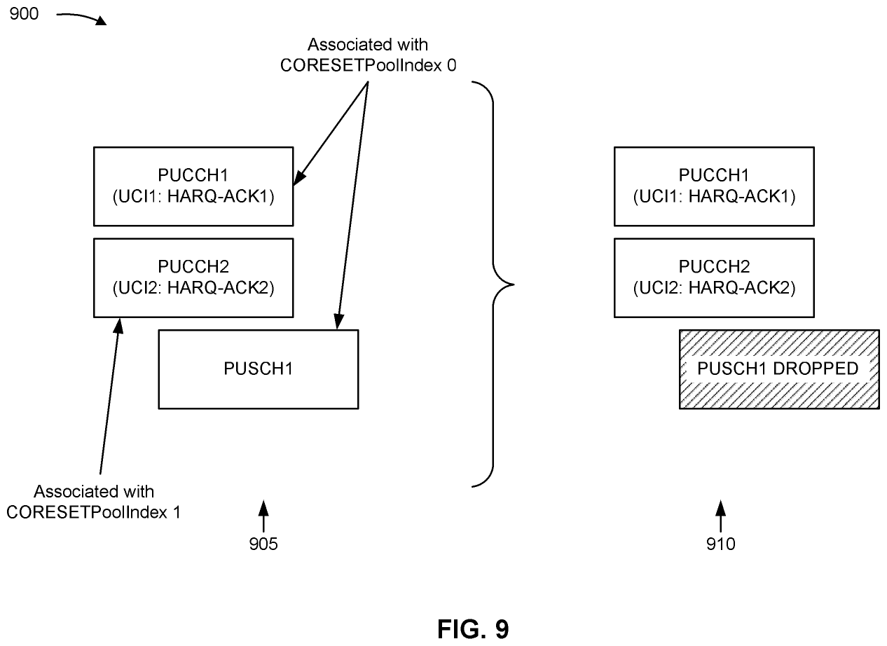

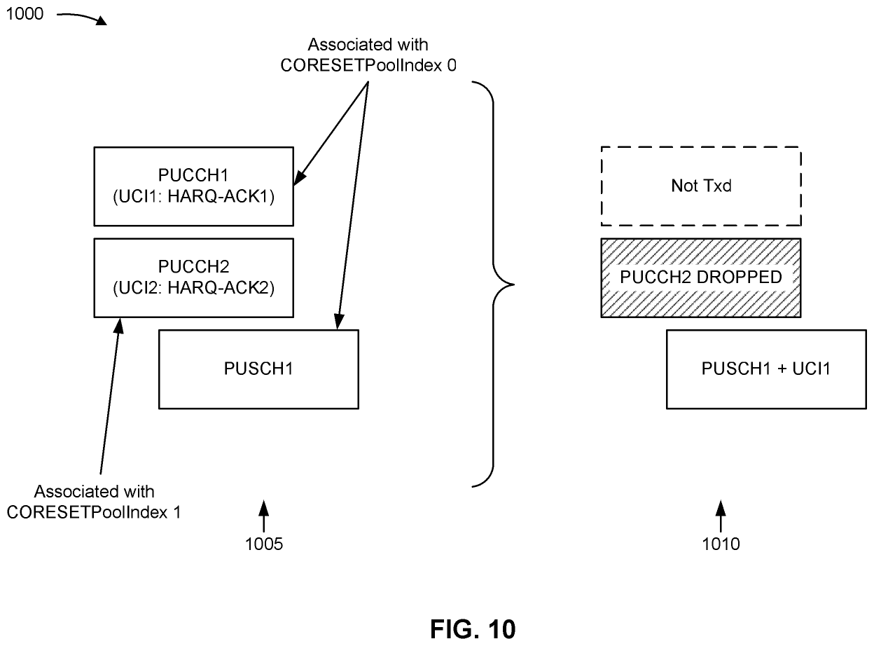

FIGS. 9 and 10 are diagrams illustrating examples 900, 1000 of transmissions using overlapping PUCCHs and PUSCHs, in accordance with the present disclosure.

In the example depicted in FIG. 9, as shown by reference number 905, the UE 120 may determine that two time-domain overlapping PUCCH resources (shown as PUCCH1 and PUCCH2 in FIG. 9) can be simultaneously transmitted in a CC or a cell, in a similar manner as described above in connection with FIGS. 7 and 8. In this aspect, however, the UE 120 may determine that one or more PUSCHs (which may be in the same CC as PUCCH1 and PUCCH2, or which may be in a different CC than PUCCH1 and PUCCH2) associated with the first CORESET pool index (e.g., CORESETPoolIndex 0) at least partially overlaps with PUCCH1, that one or more PUSCHs (which may be in the same CC as PUCCH1 and PUCCH2, or which may be in a different CC than PUCCH1 and PUCCH2) associated with the first CORESET pool index (e.g., CORESETPoolIndex 0) at least partially overlap with PUCCH2, but that no PUSCHs associated with the second CORESET pool index (e.g., CORESETPoolIndex 1) overlap with PUCCH2. For example, in FIG. 9 there is one PUSCH, shown as PUSCH1, which is associated with the first CORESET pool index (e.g., CORESETPoolIndex 0), and which at least partially overlaps with PUCCH1 and PUCCH2. However, there are no PUSCHs associated with the second CORESET pool index (e.g., CORESETPoolIndex 1) that overlap with PUCCH2.

In such aspects, the UE 120 may drop one or more PUCCHs or PUSCHs (e.g., may not transmit communications associated with one or more PUCCHs or PUSCHs) in order to avoid simultaneous transmission of a PUCCH and a PUSCH. For example, as shown by reference number 910, the UE 120 may drop PUSCH1 (indicated using cross-hatching). More particularly, the UE 120 may drop all PUSCHs associated with the first CORESET pool index (e.g., CORESETPoolIndex 0, which, in this example, is PUSCH1), and the UE 120 may simultaneously transmit PUCCH1 and PUCCH2.

In some other aspects, the UE 120 may drop one or more PUCCHs instead of one or more PUSCHs. For example, as shown by reference number 1005 in FIG. 10, the UE 120 may determine that two time-domain overlapping PUCCH resources (e.g., PUCCH1 and PUCCH2) can be simultaneously transmitted, that one or more PUSCHs associated with the first CORESET pool index (e.g., PUSCH1) at least partially overlap with PUCCH1, that one or more PUSCHs associated with the first CORESET pool index (e.g., PUSCH1) at least partially overlap with PUCCH2, and that no PUSCHs associated with the second CORESET pool index overlap with PUCCH2, in a similar manner as described above in connection with reference number 905. In this aspect, however, as shown by reference number 1010, rather than dropping a PUSCH (e.g., PUSCH1, as described in connection with FIG. 9), the UE 120 may drop PUCCH2 and thus UCI2 (e.g., the PUCCH associated with the second CORESET pool index and the associated UCI), and may multiplex UCI1 with one of the one or more PUSCHs associated with CORESETPoolIndex 0 (e.g., PUSCH1 in the depicted example).

In some other aspects, a UE 120 may not expect to be scheduled with resources resulting in two time-domain overlapping PUCCH resources (e.g., PUCCH1 and PUCCH2) that can be simultaneously transmitted, with one or more PUSCHs associated with the first CORESET pool index (e.g., PUSCH1) at least partially overlapping with PUCCH1, with one or more PUSCHs associated with the first CORESET pool index (e.g., PUSCH1) at least partially overlapping with PUCCH2, and with no PUSCHs associated with the second CORESET pool index overlapping with PUCCH2 (as described above). Thus, rather than dropping a PUSCH (as described in connection with FIG. 9) or dropping a PUCCH (as described in connection with FIG. 10), the UE 120 may determine that an error case has occurred.

In some aspects, the UE 120 may be configured to either drop a PUSCH in the scenario described in connection with reference numbers 905 and 1005 (as described in connection with FIG. 9) or drop a PUCCH in the scenario described in connection with reference numbers 905 and 1005 (as described in connection with FIG. 10). More particularly, a network entity (e.g., a base station 110, a CU 310, a DU 330, an RU 340, or a similar network entity) may transmit an RRC message or the like to the UE 120 indicating whether to drop a PUCCH or a PUSCH in the scenario described in connection with reference numbers 905 and 1005. Additionally, or alternatively, a UE 120 may determine to either drop a PUSCH in the scenario described in connection with reference numbers 905 and 1005 (as described in connection with FIG. 9), may determine to drop a PUCCH in the scenario described in connection with reference numbers 905 and 1005 (as described in connection with FIG. 10), or may determine that an error case has occurred in the above-described scenario based at least in part on UCI payload, a UCI priority, or a similar parameter. For example, a UE 120 may determine to drop a PUSCH in the scenario described in connection with reference numbers 905 and 1005 and thus transmit PUCCH2 and thus UCI2 (as described in connection with FIG. 9) based at least in part on UCI2 including a HARQ-ACK (e.g., HARQ-ACK2), which may have a higher transmission priority than a PUSCH (e.g., PUSCH1). Moreover, a UE 120 may determine to drop a PUCCH in the scenario described in connection with reference numbers 905 and 1005 and thus transmit PUSCH1 multiplexed with UCI1 but not PUCCH2 and thus UCI2 (as described in connection with FIG. 10) based at least in part on UCI2 including a periodic or semi-persistent CSI, or based at least in part on PUSCH1 including an aperiodic CSI, because an aperiodic CSI may have a higher transmission priority than a periodic or semi-persistent CSI. Moreover, a UE 120 may determine to drop a PUSCH in the scenario described in connection with reference numbers 905 and 1005 and thus transmit PUCCH2 and thus UCI2 (as described in connection with FIG. 9) based at least in part on PUSCH1 being associated with a configured grant (CG) PUSCH (CG-PUSCH), but may otherwise determine that an error case has occurred (e.g., the UE 120 may determine that an error case has occurred when PUSCH1 is not associated with a CG-PUSCH).

Although in the examples described above in connection with FIGS. 9 and 10, the PUSCH was described as being associated with the first CORESET pool index (e.g., CORESETPoolIndex 0) and at least partially overlapping with PUCCH1 and PUCCH2, in some other aspects a PUSCH may be associated with the second CORESET pool index (e.g., CORESETPoolIndex 1) and the UE 120 may act in a similar manner as described above. For example, based at least in part on the PUSCH being associated with the second CORESET pool index and overlapping with PUCCH1 and PUCCH2, the UE 120 may drop the PUSCH (analogous to the example described in connection with FIG. 9), may drop PUCCH1 and multiplex UCI2 on the PUSCH (analogous to the example described in connection with FIG. 9), or else may determine that an error case has occurred.

As indicated above, FIGS. 9 and 10 are provided as examples. Other examples may differ from what is described with respect to FIGS. 9 and 10.

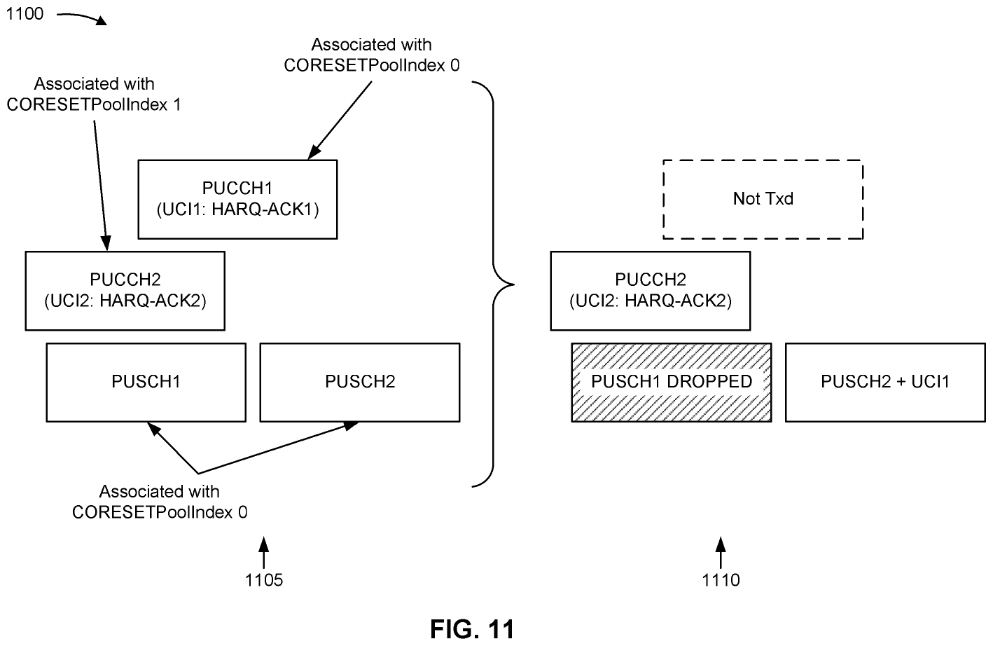

FIG. 11 is a diagram illustrating an example 1100 of transmissions using overlapping PUCCHs and PUSCHs, in accordance with the present disclosure.

In the aspect depicted in FIG. 11, and as shown by reference number 1105, the UE 120 may determine that two time-domain overlapping PUCCH resources (shown as PUCCH1 and PUCCH2 in FIG. 11) can be simultaneously transmitted in a CC or a cell, in a similar manner as described above in connection with FIGS. 7-10. The UE 120 may also identify one or more PUSCHs (which may be in the same CC as PUCCH1 and PUCCH2, or which may be in a different CC than PUCCH1 and PUCCH2) associated with the first CORESET pool index (e.g., CORESETPoolIndex 0) that overlap with PUCCH1 (e.g., the PUCCH associated with the first the first CORESET pool index), which, in this example, includes PUSCH1 and PUSCH2. Additionally, the UE 120 may identify any PUSCHs that, in addition to at least partially overlapping with PUCCH1, also overlap with PUCCH2 (e.g., the PUCCH associated with the second CORESET pool index, or CORESETPoolIndex 1). As shown at reference number 1105, in this example that is only PUSCH1.

In such aspects, if there are any remaining PUSCHs other than the PUSCHs identified as at least partially overlapping with both PUCCH1 and PUCCH2, the UE 120 may drop the PUSCHs identified as at least partially overlapping with both PUCCH1 and PUCCH2, multiplex UCI associated with PUCCH1 (e.g., UCI1) with one of the remaining PUSCHs, and transmit the remaining PUSCHs (including the PUSCH multiplexed with UCI) as well as PUCCH2 (which will not overlap with the remaining one more PUSCHs). For example, as shown by reference number 1110, the UE 120 may drop PUSCH1 (indicated using cross-hatching) because PUSCH1 was identified as at least partially overlapping with both PUCCH1 and PUCCH2, may multiplex UCI1 with one of the remaining PUSCHs (in this example PUSCH2) and thus not transmit PUCCH1 (indicated using “Not Txd”), and may transmit the non-overlapping PUCCH2 (including UCI2) and PUSCH2 (including UCI1).

In some aspects, when there are multiple candidate PUSCHs for multiplexing UCI (e.g., when there are multiple remaining PUSCHs other than the PUSCHs identified as at least partially overlapping with both PUCCH1 and PUCCH2), the UE 120 may select one of the PUSCHs (e.g., PUSCH2 in FIG. 11) for multiplexing UCI based at least in part on a prioritization rule, as described. More particularly, in some aspects, the prioritization rule may result in the UE 120 first selecting a PUSCH that is associated with a lowest CC index, and then (if more than one PUSCH is associated with the lowest CC index) selecting a PUSCH associated with an earliest starting time. In aspects in which there are no remaining PUSCHs other than the PUSCHs identified as at least partially overlapping with both PUCCH1 and PUCCH2, the UE 120 may perform as described in connection with FIGS. 9 and 10 (e.g., may either drop a PUSCH as described in connection with FIG. 9, drop a PUCCH as described in connection with FIG. 10, or determine that an error case has occurred).

Although in the example described above in connection with FIG. 11 the PUSCH identified as at least partially overlapping with both PUCCH1 and PUCCH2 was described as being associated with the first CORESET pool index (e.g., CORESETPoolIndex 0), in some other aspects the PUSCH identified as at least partially overlapping with both PUCCH1 and PUCCH2 may be associated with the second CORESET pool index (e.g., CORESETPoolIndex 1), and the UE 120 may act in a similar manner as described above. For example, based at least in part on the PUSCH identified as at least partially overlapping with both PUCCH1 and PUCCH2 being associated with the second CORESET pool index, the UE 120 may drop the PUSCH identified as at least partially overlapping with both PUCCH1 and PUCCH2 and being associated with the second CORESET pool index, may multiplex UCI2 on one of the remaining PUSCHs, and may transmit UCI1 in PUCCH1.

Moreover, and as described in connection with FIG. 5, in some aspects, a UE 120 may be capable of certain simultaneous PUCCH and PUSCH transmissions. For example, a UE 120 may be capable of simultaneous PUCCH and PUSCH transmissions if the PUCCH and the PUSCH are on different cells in inter-band carrier aggregation, and the PUCCH and the PUSCH are associated with different physical layer priority values (e.g., one of the PUCCH and the PUSCH is associated with a high priority communication, and the other one of the PUCCH and the PUSCH is associated with a low priority communication). In such aspects, for purposes of the procedures described in connection with FIGS. 7-11, the UE 120 may only consider PUSCHs (e.g., PUSCHs associated with the first CORESET pool index and PUSCHs associated with second CORESET pool index) that are in the same CC as the CC of PUCCH1 and PUCCH2, or PUSCHs that are in the same frequency band as PUCCH1 and PUCCH2. Put another way, in aspects in which the UE 120 is capable of simultaneous PUCCH and PUSCH transmissions, the UE 120 may not consider for UCI multiplexing PUSCHs in CCs and/or frequency bands other than the CC and/or frequency band associated with PUCCH1 and PUCCH2. Additionally, or alternatively, for purposes of the aspects described in connection with FIGS. 7-11, the UE 120 may only consider PUSCHs (e.g., PUSCHs associated with the first CORESET pool index and PUSCHs associated with second CORESET pool index) that are associated with a certain physical layer priority (e.g., a same physical layer priority as PUCCH1 and/or PUCCH2). More particularly, in some aspects, the UE 120 may consider, for purposes of the aspects described in connection with FIGS. 7-11, one or more PUSCHs in CCs and/or frequency bands other than the CC and/or frequency band associated with PUCCH1 and PUCCH2 as long as a physical layer priority of the one or more PUSCHs is the same as the physical layer priority of the PUCCH1 and/or PUCCH2.

As indicated above, FIG. 11 is provided as an example. Other examples may differ from what is described with respect to FIG. 11.

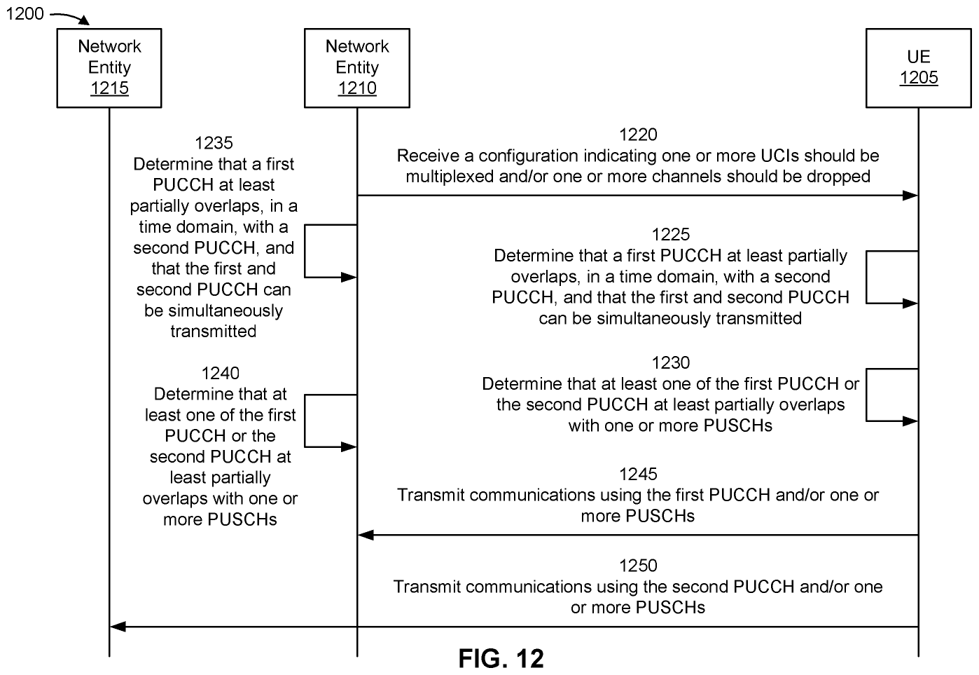

FIG. 12 is a diagram of an example 1200 associated with transmissions using overlapping PUCCHs and PUSCHs, in accordance with the present disclosure. As shown in FIG. 12, a UE 1205 (e.g., UE 120), a first network entity 1210 (e.g., a base station 110, a CU 310, a DU 330, an RU 340, a TRP 605, or a similar network entity), and a second network entity 1215 (e.g., a base station 110, a CU 310, a DU 330, an RU 340, a TRP 605, or a similar network entity) may communicate with one another. In some aspects, the UE 1205, the first network entity 1210, and the second network entity 1215 may be part of a wireless network (e.g., wireless network 100). The UE 1205, the first network entity 1210, and the second network entity 1215 may have established a wireless connection prior to operations shown in FIG. 12. In some aspects, the UE 1205, the first network entity 1210, and the second network entity 1215 may be operating in a multi-TRP and/or multi-DCI scenario. In such aspects, the first network entity 1210 may correspond to a first TRP (e.g., TRP A described in connection with FIG. 6) and the second network entity 1215 may correspond to a second TRP (e.g., TRP B described in connection with FIG. 6). Additionally, or alternatively, the first network entity 1210 may be associated with a first CORESET pool index (e.g., CORESETPoolIndex 0), and the second network entity 1215 may correspond to a second CORESET pool index (e.g., CORESETPoolIndex 1).

As shown by reference number 1220, the UE 1205 may receive, from a network entity (e.g., the first network entity 1210 in FIG. 12, but which may be the second network entity 1215 in other aspects without departing from the scope of the disclosure), configuration information. In some aspects, the UE 1205 may receive the configuration information via one or more of RRC signaling, one or more MAC control elements (MAC-CEs), and/or DCI, among other examples. In some aspects, the configuration information may include an indication of one or more configuration parameters (e.g., already known to the UE 1205 and/or previously indicated by the network node or other network device) for selection by the UE 1205, and/or explicit configuration information for the UE 1205 to use to configure the UE 1205, among other examples.

In some aspects, the configuration information may indicate that the UE 1205 is to, based at least in part on the UE 1205 being scheduled with overlapping physical channels (e.g., overlapping PUCCHs and/or PUSCHs), multiplex UCI with a PUSCH and/or drop communications associated with a PUCCH and/or a PUSCH. For example, the configuration information may configure the UE 1205 to perform one or more of the operations described in connection with FIGS. 7-11. The UE 1205 may configure itself based at least in part on the configuration information.

As shown by reference number 1225, the UE 1205 may determine that a first PUCCH at least partially overlaps, in a time domain, with a second PUCCH, and that the first PUCCH and the second PUCCH can be simultaneously transmitted. For example, the UE 1205 may determine that PUCCH1 and PUCCH2 described in connection with FIGS. 7-11 at least partially overlap in the time domain. Moreover, the UE 1205 may determine that PUCCH1 and PUCCH2 may be simultaneously transmitted based at least in part on configuration information, such as configuration information received via the configuration described in connection with reference number 1220. For example, the configuration information may include a feedback mode parameter (e.g., ackNackFeedbackMode) indicating that the UE 120 may transmit at least partially overlapping PUCCHs for purposes of providing separate HARQ feedback (e.g., the UE 120 may be configured with ackNackFeedbackMode as “separate”). In such aspects, the UE 120 may determine that PUCCH1 and PUCCH2 may be simultaneously transmitted based at least in part on UCI associated with PUCCH1 (e.g., UCI) including a first HARQ feedback communication (e.g., HARQ-ACK1) and UCI associated with PUCCH2 (e.g., UCI2) including a second HARQ feedback communication (e.g., HARQ-ACK2). Moreover, in some aspects, the UE 1205 may determine that UCI1 is associated with a first CORESET pool index (e.g., CORESETPoolIndex 0), and/or the UE 1205 may determine that UCI2 is associated with a second CORESET pool index (e.g., CORESETPoolIndex 1). In some aspects, the UE 1205 may determine the PUCCH1 and PUCCH2 after performing UCI multiplexing procedures for overlapping PUCCHs, such as the UCI multiplexing procedures described above in connection with FIG. 5.

As shown by reference number 1230, the UE 1205 may determine that at least one of PUCCH1 or PUCCH2 at least partially overlaps, in the time domain, with one or more PUSCHs. For example, the UE 1205 may determine that at least one of PUCCH1 or PUCCH2 overlaps with one of the PUSCHs described in connection with FIGS. 7-11.

In some aspects, one or both of the network entities 1210, 1215 may perform substantially similar determinations as described above in connection with reference numbers 1225 and 1230 instead of, or in addition to, the UE 1205. For example, as shown by reference number 1235, in some aspects the first network entity 1210 may determine that PUCCH1 at least partially overlaps, in a time domain, with PUCCH2, and that the UE 1205 is capable of simultaneous transmission of PUCCH1 and PUCCH2, with PUCCH1 including UCI1 associated with a first CORESET pool index (e.g., CORESETPoolIndex 0), with PUCCH2 including UCI2 associated with a second CORESET pool index (e.g., CORESETPoolIndex 1), and with PUCCH1 and PUCCH2 being determined after considering UCI multiplexing procedures for overlapping PUCCHs. Moreover, as shown by reference number 1240, the first network entity 1210 may determine that at least one of PUCCH1 or PUCCH2 at least partially overlaps, in the time domain, with one or more PUSCHs.

As shown by reference numbers 1245 and 1250, the UE 1205 may transmit communications using PUCCH1, PUCCH2, and one or more PUSCHs to the first network entity 1210 and/or the second network entity 1215. In some aspects, the UE 1205 may transmit communications using less than all of PUCCH1, PUCCH2, and the one or more PUSCHs based at least in part on at least one of multiplexing at least one of UCI1 or UCI2 with at least one PUSCH, of the one or more PUSCHs, or dropping communications associated with at least one of PUCCH1, PUCCH2, or the one or more PUSCHs. For example, the UE 1205 may transmit communications to one or both of the first network entity 1210 and the second network entity 1215 in a manner described in connection with FIGS. 7-11. In that regard, and as described, in some aspects PUCCH1 and PUCCH2 may be associated with a first CC, and the one or more PUSCHs may be associated with the first CC or with a second CC different than the first CC.

Moreover, as described above in connection with FIG. 7, in some aspects a first PUSCH (e.g., one of PUSCH1 or PUSCH2 shown at reference number 705) may be associated with the first CORESET pool index (e.g., CORESETPoolIndex 0) and may at least partially overlap, in the time domain, with PUCCH1, and a second PUSCH (e.g., the other one of PUSCH1 or PUSCH2) may be associated with the second CORESET pool index (e.g., CORESETPoolIndex 1) and may at least partially overlap, in the time domain, with PUCCH2. In such aspects, as described above in connection with reference number 710, UCI1 may be multiplexed on the first PUSCH (e.g., PUSCH1 in FIG. 7), and UCI2 may be multiplexed on the second PUSCH (e.g., PUSCH2 in FIG. 7).

In some aspects, additional PUSCHs may overlap with one or more of the PUCCHs. For example, a third PUSCH may also be associated with the first CORESET pool index (e.g., CORESETPoolIndex 0) and may at least partially overlap, in the time domain, with PUCCH1. In such aspects, UCI1 may be multiplexed on the first PUSCH (and not the third PUSCH) based at least in part on a UCI multiplexing prioritization rule or the like. For example, UCI1 may be multiplexed on the first PUSCH based at least in part on one of the first PUSCH being associated with a lower CC index than the third PUSCH, or the first PUSCH beginning earlier than the third PUSCH and the first PUSCH and the third PUSCH being associated with a same CC.

Alternatively, a third PUSCH may be associated with the second CORESET pool index (e.g., CORESETPoolIndex 1) and may at least partially overlap, in the time domain, with PUCCH2. In such aspects, UCI2 may be multiplexed on the second PUSCH (and not on the third PUSCH) based at least in part on one of the second PUSCH being associated with a lower CC index than the third PUSCH, or the second PUSCH beginning earlier than the third PUSCH and the second PUSCH and the third PUSCH being associated with a same CC.

In some aspects, and as described in connection with FIG. 8, a PUSCH (e.g., PUSCH1) associated with the first CORESET pool index (e.g., CORESETPoolIndex 0) may at least partially overlap, in the time domain, with PUCCH1, and no PUSCHs may overlap, in the time domain, with PUCCH2. In such aspects, the UCI1 may be multiplexed on the PUSCH that is associated with the first CORESET pool index and at least partially overlaps, in the time domain, with PUCCH1 (e.g., PUSCH1 in FIG. 8), and UCI2 may be transmitted using PUCCH2, as described in connection with reference number 810. Again, when one more additional PUSCHs associated with the first CORESET pool index overlap with PUCCH1, UCI1 may be multiplexed on PUSCH1 (and not on another overlapping PUSCH) based at least in part on one of PUSCH1 being associated with a lower CC index than the one or more other PUSCHs, or PUSCH1 beginning earlier than the one or more other PUSCHs and PUSCH1 and the one or more other PUSCHs being associated with a same CC.

In some aspects, and as described in connection with FIGS. 9-10, at least one PUSCH (e.g., PUSCH1 in FIGS. 9 and 10) associated with the first CORESET pool index (e.g., CORESETPoolIndex 0) may at least partially overlap, in the time domain, with PUCCH1, at least one PUSCH (e.g., PUSCH1 in FIGS. 9 and 10) associated with the first CORESET pool index may at least partially overlap, in the time domain, with PUCCH2, and no PUSCHs associated with the second CORESET pool index (e.g., CORESETPoolIndex 0) may overlap, in the time domain, with PUCCH2. In such a case, the UE 1205 may alternatively perform in one of several ways.

In some aspects, as described in connection with reference number 910, communications associated with PUSCHs associated with the first CORESET pool index (e.g., PUSCH1 in FIG. 9) may be dropped, UCI1 may be transmitted using PUCCH1, and UCI2 may be transmitted using PUCCH2. In some aspects, the UE 1205 may receive a configuration indicating that one or more PUSCHs associated with the first CORESET pool index should be dropped, which may be included as part of the configuration information described in connection with reference number 1220. Additionally, or alternatively, one or more PUSCHs associated with the first CORESET pool index may be dropped based at least in part on a type of communication associated with the PUCCHs or the PUSCHs. More particularly, one or more PUSCHs associated with the first CORESET pool index may be dropped based at least in part on UCI2 including a HARQ-ACK message (e.g., HARQ-ACK2 in FIG. 9), which may be have a higher priority than a PUSCH. Additionally, or alternatively, one or more PUSCHs associated with the first CORESET pool index may be dropped based at least in part on the one or more PUSCHs being associated with a CG-PUSCH, which may have a lower priority than a PUCCH.

In some other aspects, as described in connection with reference number 1010, UCI2 may be dropped, and UCI1 may be multiplexed with one of one or more PUSCHs associated with the first CORESET pool index (e.g., PUSCH1 in FIG. 10). In some aspects, the UE 1205 may receive a configuration indicating that UCI2 should be dropped, which may be included as part of the configuration information described in connection with reference number 1220. Additionally, or alternatively, UCI2 may be dropped based at least in part on a type of CSI associated with the PUCCHs or the PUSCHs. More particularly, UCI2 may be dropped based at least in part on at least one of UCI2 including a periodic or semi-persistent CSI report, or at least one PUSCH, of the one or more PUSCHs associated with the first CORESET pool index (e.g., PUSCH1 in FIG. 10) including an aperiodic CSI report.

In some other aspects, the UE 1205 may not expect the case to occur where at least one PUSCH (e.g., PUSCH1 in FIGS. 9 and 10) associated with the first CORESET pool index (e.g., CORESETPoolIndex 0) at least partially overlaps, in the time domain, with PUCCH1, where at least one PUSCH associated with the first CORESET (e.g., PUSCH1) pool index at least partially overlaps, in the time domain, with PUCCH2, and where no PUSCHs associated with the second CORESET pool index (e.g., CORESETPoolIndex 0) overlap, in the time domain, with PUCCH2. Thus, in such aspects, when faced with the case shown at reference numbers 905 and 1005, the UE 1205 may determine that an error case has occurred.

In some aspects, as described in connection with FIG. 11, the UE 1205 may identify at least one PUSCH (e.g., PUSCH1 in FIG. 11) that at least partially overlaps, in the time domain, with both PUCCH1 and PUCCH2, and may identify one or more remaining PUSCHs (e.g., PUSCH2 in FIG. 11) associated with the first CORESET pool index (e.g., CORESETPoolIndex 0) overlapping with PUCCH1 after excluding the at least one PUSCH that at least partially overlaps with both PUCCH1 and PUCCH2. In such aspects, the UE 1205 may drop communications associated with the at least one PUSCH that at least partially overlap with both the first PUCCH and the second PUCCH (e.g., the UE 1205 may drop the communications associated with PUSCH1 in FIG. 11), multiplex UCI1 with a PUSCH among the one or more remaining PUSCHs (e.g., PUSCH2 in FIG. 11), and may transmit communications associated with the one or more remaining PUSCHs and UCI2 using the second PUCCH, as described in connection with reference number 1110. Moreover, if more than one remaining PUSCHs are available for multiplexing UCI1, the UE 1205 may multiplex UCI1 with a PUSCH associated with a lowest CC index, or may multiplex UCI1 with a PUSCH with an earliest starting time based at least in part on the one or more remaining PUSCHs being associated with a same CC, as described.

As indicated above, FIG. 12 is provided as an example. Other examples may differ from what is described with respect to FIG. 12.

FIG. 13 is a diagram illustrating an example process 1300 performed, for example, by a UE, in accordance with the present disclosure. Example process 1300 is an example where the UE (e.g., UE 1205) performs operations associated with transmissions using overlapping PUCCHs and PUSCHs.

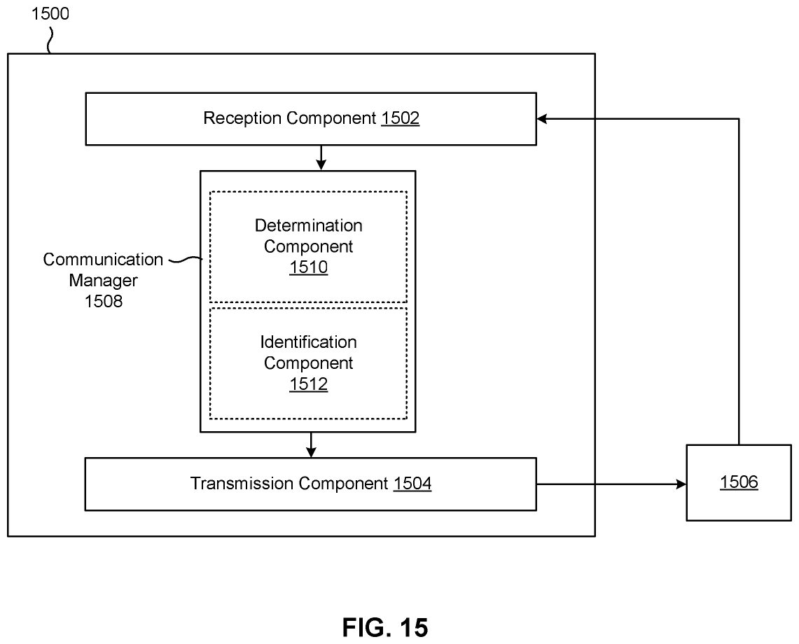

As shown in FIG. 13, in some aspects, process 1300 may include determining that a PUCCH at least partially overlaps, in a time domain, with a second PUCCH, and that the first PUCCH and the second PUCCH can be simultaneously transmitted, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs (block 1310). For example, the UE (e.g., using communication manager 1508 and/or determination component 1510, depicted in FIG. 15) may determine that a first PUCCH at least partially overlaps, in a time domain, with a second PUCCH, and that the first PUCCH and the second PUCCH can be simultaneously transmitted, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs, as described above.

As further shown in FIG. 13, in some aspects, process 1300 may include determining that at least one of the first PUCCH or the second PUCCH at least partially overlaps, in the time domain, with one or more PUSCHs (block 1320). For example, the UE (e.g., using communication manager 1508 and/or determination component 1510, depicted in FIG. 15) may determine that at least one of the first PUCCH or the second PUCCH at least partially overlaps, in the time domain, with one or more PUSCHs, as described above.

As further shown in FIG. 13, in some aspects, process 1300 may include transmitting communications using less than all of the first PUCCH, the second PUCCH, and the one or more PUSCHs based at least in part on at least one of: multiplexing at least one of the first UCI or the second UCI with at least one PUSCH, of the one or more PUSCHs, or dropping communications associated with at least one of the first PUCCH, the second PUCCH, or the one or more PUSCHs (block 1330). For example, the UE (e.g., using communication manager 1508 and/or transmission component 1504, depicted in FIG. 15) may transmit communications using less than all of the first PUCCH, the second PUCCH, and the one or more PUSCHs based at least in part on at least one of: multiplexing at least one of the first UCI or the second UCI with at least one PUSCH, of the one or more PUSCHs, or dropping communications associated with at least one of the first PUCCH, the second PUCCH, or the one or more PUSCHs, as described above.

Process 1300 may include additional aspects, such as any single aspect or any combination of aspects described below and/or in connection with one or more other processes described elsewhere herein.

In a first aspect, the first PUCCH and the second PUCCH are associated with a first component carrier.

In a second aspect, alone or in combination with the first aspect, the one or more PUSCHs are associated with the first component carrier.

In a third aspect, alone or in combination with the first aspect, the one or more PUSCHs are associated with a second component carrier different than the first component carrier.

In a fourth aspect, alone or in combination with one or more of the first through third aspects, a first PUSCH, of the one or more PUSCHs, is associated with the first CORESET pool index and at least partially overlaps, in the time domain, with the first PUCCH, a second PUSCH, of the one or more PUSCHs, is associated with the second CORESET pool index and at least partially overlaps, in the time domain, with the second PUCCH, the first UCI is multiplexed on the first PUSCH, and the second UCI is multiplexed on the second PUSCH.

In a fifth aspect, alone or in combination with one or more of the first through fourth aspects, a third PUSCH, of the one or more PUSCHs, is associated with the first CORESET pool index and at least partially overlaps, in the time domain, with the first PUCCH, and the first UCI is multiplexed on the first PUSCH based at least in part on one of the first PUSCH being associated with a lower component carrier index than the third PUSCH, or the first PUSCH beginning earlier than the third PUSCH and the first PUSCH and the third PUSCH being associated with a same component carrier.

In a sixth aspect, alone or in combination with one or more of the first through fifth aspects, a third PUSCH, of the one or more PUSCHs, is associated with the second CORESET pool index and at least partially overlaps, in the time domain, with the second PUCCH, and the second UCI is multiplexed on the second PUSCH based at least in part on one of the second PUSCH being associated with a lower component carrier index than the third PUSCH, or the second PUSCH beginning earlier than the third PUSCH and the second PUSCH and the third PUSCH being associated with a same component carrier.

In a seventh aspect, alone or in combination with one or more of the first through sixth aspects, a first PUSCH, of the one or more PUSCHs, is associated with the first CORESET pool index and at least partially overlaps, in the time domain, with the first PUCCH, no PUSCHs overlap, in the time domain, with the second PUCCH, the first UCI is multiplexed on the first PUSCH, and the second UCI is transmitted using the second PUCCH.

In an eighth aspect, alone or in combination with one or more of the first through seventh aspects, a third PUSCH, of the one or more PUSCHs, is associated with the first CORESET pool index and at least partially overlaps, in the time domain, with the first PUCCH, and the first UCI is multiplexed on the first PUSCH based at least in part on one of the first PUSCH being associated with a lower component carrier index than the third PUSCH, or the first PUSCH beginning earlier than the third PUSCH and the first PUSCH and the third PUSCH being associated with a same component carrier.

In a ninth aspect, alone or in combination with one or more of the first through eighth aspects, at least one PUSCH, of the one or more PUSCHs, is associated with the first CORESET pool index and at least partially overlaps, in the time domain, with the first PUCCH, at least one PUSCH, of the one or more PUSCHs, is associated with the first CORESET pool index and at least partially overlaps, in the time domain, with the second PUCCH, and no PUSCHs associated with the second CORESET pool index overlap, in the time domain, with the second PUCCH.

In a tenth aspect, alone or in combination with one or more of the first through ninth aspects, communications associated with the PUSCHs associated with the first CORESET pool index are dropped, the first UCI is transmitted using the first PUCCH, and the second UCI is transmitted using the second PUCCH.

In an eleventh aspect, alone or in combination with one or more of the first through tenth aspects, process 1300 includes receiving a configuration indicating that the PUSCHs associated with the first CORESET pool index should be dropped.

In a twelfth aspect, alone or in combination with one or more of the first through eleventh aspects, the PUSCHs associated with the first CORESET pool index are dropped based at least in part on the second UCI including a hybrid automatic repeat request acknowledgement message.

In a thirteenth aspect, alone or in combination with one or more of the first through twelfth aspects, the PUSCHs associated with the first CORESET pool index are dropped based at least in part on the PUSCHs associated with the first CORESET pool index being associated with a configured grant PUSCH.

In a fourteenth aspect, alone or in combination with one or more of the first through thirteenth aspects, the second UCI is dropped, and the first UCI is multiplexed with one of one or more PUSCHs associated with the first CORESET pool index that overlap with the first PUCCH.

In a fifteenth aspect, alone or in combination with one or more of the first through fourteenth aspects, process 1300 includes receiving a configuration indicating that the second UCI should be dropped.

In a sixteenth aspect, alone or in combination with one or more of the first through fifteenth aspects, the second UCI is dropped based at least in part on at least one of the second UCI includes a periodic or semi-persistent CSI report, or at least one PUSCH, of the one or more PUSCHs, includes an aperiodic CSI report.

In a seventeenth aspect, alone or in combination with one or more of the first through sixteenth aspects, the UE determines that an error case has occurred.

In an eighteenth aspect, alone or in combination with one or more of the first through seventeenth aspects, process 1300 includes identifying at least one PUSCH, of the one or more PUSCHs, that at least partially overlaps, in time domain, with both the first PUCCH and the second PUCCH, and performing the following actions based at least in part on there being one or more remaining PUSCHs associated with the first CORESET pool index and overlapping with the first PUCCH after excluding the at least one PUSCH that at least partially overlaps with both the first PUCCH and the second PUCCH: dropping communications associated with the at least one PUSCH that at least partially overlaps with both the first PUCCH and the second PUCCH, multiplexing the first UCI with a PUSCH among the one or more remaining PUSCHs, and transmitting communications associated with the one or more remaining PUSCHs and the second UCI using the second PUCCH.

In a nineteenth aspect, alone or in combination with one or more of the first through eighteenth aspects, multiplexing the first UCI with the PUSCH among the one or more remaining PUSCHs further comprises multiplexing the first UCI with a PUSCH associated with a lowest component carrier index among the one or more remaining PUSCHs, or multiplexing the first UCI with a PUSCH with an earliest starting time based at least in part on the one or more remaining PUSCHs being associated with a same component carrier.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a network entity, in accordance with the present disclosure. Example process 1400 is an example where the network entity (e.g., network entity 1210 or network entity 1215) performs operations associated with transmissions using overlapping PUCCHs and PUSCHs.

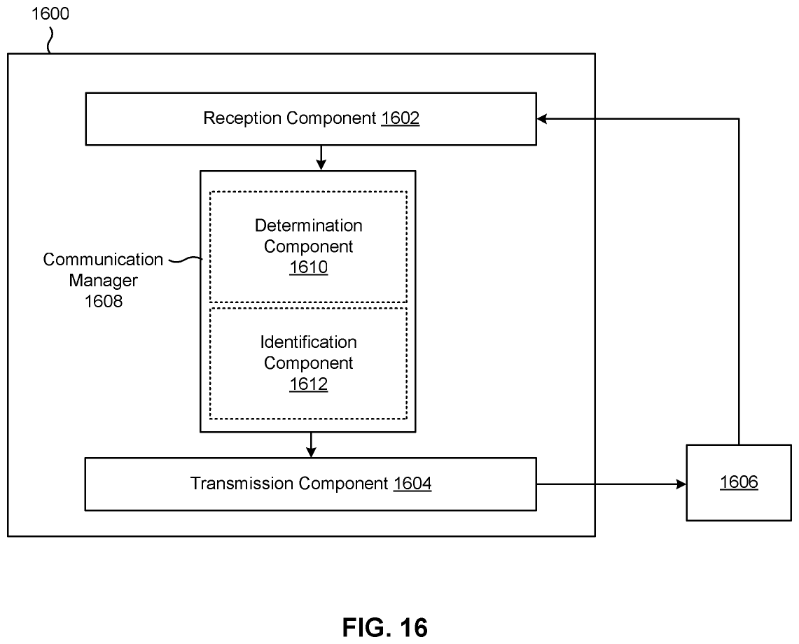

As shown in FIG. 14, in some aspects, process 1400 may include determining that a first PUCCH associated with a UE (e.g., UE 1205) at least partially overlaps, in a time domain, with a second PUCCH, and that the UE is capable of simultaneous transmission of the first PUCCH and the second PUCCH, wherein the first PUCCH includes a first UCI associated with a first CORESET pool index, the second PUCCH includes a second UCI associated with a second CORESET pool index, and the first PUCCH and the second PUCCH are determined after considering UCI multiplexing procedures for overlapping PUCCHs (block 1410). For example, the network entity (e.g., using communication manager 1608 and/or determination component 1610, depicted in FIG. 16) may determine that a first PUCCH associated with a UE at least partially overlaps, in a time domain, with a second PUCCH, and that the UE is capable of simultaneous transmission of the first PUCCH and the second PUCCH, wherein the first PUCCH includes a first UCI associated with a first CORESET pool index, the second PUCCH includes a second UCI associated with a second CORESET pool index, and the first PUCCH and the second PUCCH are determined after considering UCI multiplexing procedures for overlapping PUCCHs, as described above.

As further shown in FIG. 14, in some aspects, process 1400 may include determining that at least one of the first PUCCH or the second PUCCH at least partially overlaps, in the time domain, with one or more PUSCHs (block 1420). For example, the network entity (e.g., using communication manager 1608 and/or determination component 1610, depicted in FIG. 16) may determine that at least one of the first PUCCH or the second PUCCH at least partially overlaps, in the time domain, with one or more PUSCHs, as described above.

As further shown in FIG. 14, in some aspects, process 1400 may include receiving, from the UE, a communication based at least in part on the determination, wherein the communication includes at least one of the first UCI or the second UCI multiplexed with at least one PUSCH, of the one or more PUSCHs (block 1430). For example, the network entity (e.g., using communication manager 1608 and/or reception component 1602, depicted in FIG. 16) may receive, from the UE, a communication based at least in part on the determination, wherein the communication includes at least one of the first UCI or the second UCI multiplexed with at least one PUSCH, of the one or more PUSCHs, as described above.

Process 1400 may include additional aspects, such as any single aspect or any combination of aspects described below and/or in connection with one or more other processes described elsewhere herein.

In a first aspect, the first PUCCH and the second PUCCH are associated with a first component carrier.

In a second aspect, alone or in combination with the first aspect, the one or more PUSCHs are associated with the first component carrier.

In a third aspect, alone or in combination with the first aspect, the one or more PUSCHs are associated with a second component carrier different than the first component carrier.

In a fourth aspect, alone or in combination with one or more of the first through third aspects, a first PUSCH, of the one or more PUSCHs, is associated with the first CORESET pool index and at least partially overlaps, in the time domain, with the first PUCCH, a second PUSCH, of the one or more PUSCHs, is associated with the second CORESET pool index and at least partially overlaps, in the time domain, with the second PUCCH, the first UCI is multiplexed on the first PUSCH, and the second UCI is multiplexed on the second PUSCH.

In a fifth aspect, alone or in combination with one or more of the first through fourth aspects, a third PUSCH, of the one or more PUSCHs, is associated with the first CORESET pool index and at least partially overlaps, in the time domain, with the first PUCCH, and the first UCI is multiplexed on the first PUSCH based at least in part on one of the first PUSCH being associated with a lower component carrier index than the third PUSCH, or the first PUSCH beginning earlier than the third PUSCH and the first PUSCH and the third PUSCH being associated with a same component carrier.

In a sixth aspect, alone or in combination with one or more of the first through fifth aspects, a first PUSCH, of the one or more PUSCHs, is associated with the first CORESET pool index and at least partially overlaps, in the time domain, with the first PUCCH, no PUSCHs overlap, in the time domain, with the second PUCCH, and the network entity receives at least one of the first UCI multiplexed on the first PUSCH, or the second UCI in the second PUCCH.

In a seventh aspect, alone or in combination with one or more of the first through sixth aspects, a third PUSCH, of the one or more PUSCHs, is associated with the first CORESET pool index and at least partially overlaps, in the time domain, with the first PUCCH, and the first UCI is multiplexed on the first PUSCH based at least in part on one of the first PUSCH being associated with a lower component carrier index than the third PUSCH, or the first PUSCH beginning earlier than the third PUSCH and the first PUSCH and the third PUSCH being associated with a same component carrier.

In an eighth aspect, alone or in combination with one or more of the first through seventh aspects, at least a first PUSCH, of the one or more PUSCHs, is associated with the first CORESET pool index and at least partially overlaps, in the time domain, with the first PUCCH, at least a second PUSCH, of the one or more PUSCHs, is associated with the first CORESET pool index and at least partially overlaps, in the time domain, with the second PUCCH, and no PUSCHs associated with the second CORESET pool index overlap, in the time domain, with the second PUCCH.

In a ninth aspect, alone or in combination with one or more of the first through eighth aspects, the network entity receives the first UCI multiplexed with one of the first PUSCH or the second PUSCH.

In a tenth aspect, alone or in combination with one or more of the first through ninth aspects, process 1400 includes transmitting, to the UE, a configuration indicating that the second UCI should be dropped.

In an eleventh aspect, alone or in combination with one or more of the first through tenth aspects, process 1400 includes identifying at least one PUSCH, of the one or more PUSCHs, that at least partially overlaps, in time domain, with both the first PUCCH and the second PUCCH, and based at least in part on there being one or more remaining PUSCHs associated with the first CORESET pool index and overlapping with the first PUCCH after excluding the at least one PUSCH that at least partially overlaps with both the first PUCCH and the second PUCCH, receiving at least one of the first UCI in a PUSCH among the one or more remaining PUSCHs, or the second UCI in the second PUCCH.

In a twelfth aspect, alone or in combination with one or more of the first through eleventh aspects, receiving the first UCI in the PUSCH among the one or more remaining PUSCHs further comprises receiving the first UCI in a PUSCH associated with a lowest component carrier index among the one or more remaining PUSCHs, or receiving the first UCI in a PUSCH with an earliest starting time based at least in part on the one or more remaining PUSCHs being associated with a same component carrier.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE (e.g., UE 1205), or a UE may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 1508. The communication manager 1508 may include one or more of a determination component 1510, and an identification component 1512, among other examples.

In some aspects, the apparatus 1500 may be configured to perform one or more operations described herein in connection with FIGS. 7-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE 120 described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the UE 120 described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the UE 120 described in connection with FIG. 2. In some aspects, the transmission component 1504 may be co-located with the reception component 1502 in a transceiver.

The determination component 1510 may determine that a first PUCCH at least partially overlaps, in a time domain, with a second PUCCH, and that the first PUCCH and the second PUCCH can be simultaneously transmitted, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs. The determination component 1510 may determine that at least one of the first PUCCH or the second PUCCH at least partially overlaps, in the time domain, with one or more PUSCHs. The transmission component 1504 may transmit communications using less than all of the first PUCCH, the second PUCCH, and the one or more PUSCHs based at least in part on at least one of multiplexing at least one of the first UCI or the second UCI with at least one PUSCH, of the one or more PUSCHs, or dropping communications associated with at least one of the first PUCCH, the second PUCCH, or the one or more PUSCHs.

The reception component 1502 may receive a configuration indicating that the PUSCHs associated with the first CORESET pool index should be dropped.

The reception component 1502 may receive a configuration indicating that the second UCI should be dropped.

The identification component 1512 may identify at least one PUSCH, of the one or more PUSCHs, that at least partially overlaps, in time domain, with both the first PUCCH and the second PUCCH.

The determination component 1510 and/or the transmission component 1504 may perform the following actions based at least in part on there being one or more remaining PUSCHs associated with the first CORESET pool index and overlapping with the first PUCCH after excluding the at least one PUSCH that at least partially overlaps with both the first PUCCH and the second PUCCH dropping communications associated with the at least one PUSCH that at least partially overlaps with both the first PUCCH and the second PUCCH; multiplexing the first UCI with a PUSCH among the one or more remaining PUSCHs; and transmitting communications associated with the one or more remaining PUSCHs and the second UCI using the second PUCCH.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network entity (e.g., network entity 1210 or network entity 1215), or a network entity may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include the communication manager 1608. The communication manager 1608 may include one or more of a determination component 1610, or an identification component 1612, among other examples.

In some aspects, the apparatus 1600 may be configured to perform one or more operations described herein in connection with FIGS. 7-12. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the base station 110 described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the base station 110 described in connection with FIG. 2.

The transmission component 1604 may transmit communications, such as reference signals, control information, data communications, or a combination thereof, to the apparatus 1606. In some aspects, one or more other components of the apparatus 1600 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modem, a modulator, a transmit MIMO processor, a transmit processor, a controller/processor, a memory, or a combination thereof, of the base station 110 described in connection with FIG. 2. In some aspects, the transmission component 1604 may be co-located with the reception component 1602 in a transceiver.

The determination component 1610 may determine that a first PUCCH associated with a UE at least partially overlaps, in a time domain, with a second PUCCH, and that the UE is capable of simultaneous transmission of the first PUCCH and the second PUCCH, wherein the first PUCCH includes a first UCI associated with a first CORESET pool index, the second PUCCH includes a second UCI associated with a second CORESET pool index, and the first PUCCH and the second PUCCH are determined after considering UCI multiplexing procedures for overlapping PUCCHs. The determination component 1610 may determine that at least one of the first PUCCH or the second PUCCH at least partially overlaps, in the time domain, with one or more PUSCHs. The reception component 1602 may receive, from the UE, a communication based at least in part on the determination, wherein the communication includes at least one of the first UCI or the second UCI multiplexed with at least one PUSCH, of the one or more PUSCHs.

The transmission component 1604 may transmit, to the UE, a configuration indicating that the second UCI should be dropped.

The identification component 1612 may identify at least one PUSCH, of the one or more PUSCHs, that at least partially overlaps, in time domain, with both the first PUCCH and the second PUCCH.

The reception component 1602 may receive, based at least in part on there being one or more remaining PUSCHs associated with the first CORESET pool index and overlapping with the first PUCCH after excluding the at least one PUSCH that at least partially overlaps with both the first PUCCH and the second PUCCH, at least one of the first UCI in a PUSCH among the one or more remaining PUSCHs, or the second UCI in the second PUCCH.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by UE, comprising: determining that a first PUCCH at least partially overlaps, in a time domain, with a second PUCCH, and that the first PUCCH and the second PUCCH can be simultaneously transmitted, wherein the first PUCCH includes a first UCI associated with a first CORESET pool index, the second PUCCH includes a second UCI associated with a second CORESET pool index, and the first PUCCH and the second PUCCH are determined after performing UCI multiplexing procedures for overlapping PUCCHs; and determining that at least one of the first PUCCH or the second PUCCH at least partially overlaps, in the time domain, with one or more PUSCHs; and transmitting communications using less than all of the first PUCCH, the second PUCCH, and the one or more PUSCHs based at least in part on at least one of: multiplexing at least one of the first UCI or the second UCI with at least one PUSCH, of the one or more PUSCHs, or dropping communications associated with at least one of the first PUCCH, the second PUCCH, or the one or more PUSCHs.

Aspect 2: The method of Aspect 1, wherein the first PUCCH and the second PUCCH are associated with a first component carrier.

Aspect 3: The method of Aspect 2, wherein the one or more PUSCHs are associated with the first component carrier.

Aspect 4: The method of Aspect 2, wherein the one or more PUSCHs are associated with a second component carrier different than the first component carrier.

Aspect 5: The method of any of Aspects 1-4, wherein a first PUSCH, of the one or more PUSCHs, is associated with the first CORESET pool index and at least partially overlaps, in the time domain, with the first PUCCH, wherein a second PUSCH, of the one or more PUSCHs, is associated with the second CORESET pool index and at least partially overlaps, in the time domain, with the second PUCCH, wherein the first UCI is multiplexed on the first PUSCH, and wherein the second UCI is multiplexed on the second PUSCH.

Aspect 6: The method of Aspect 5, wherein a third PUSCH, of the one or more PUSCHs, is associated with the first CORESET pool index and at least partially overlaps, in the time domain, with the first PUCCH, and wherein the first UCI is multiplexed on the first PUSCH based at least in part on one of the first PUSCH being associated with a lower component carrier index than the third PUSCH, or the first PUSCH beginning earlier than the third PUSCH and the first PUSCH and the third PUSCH being associated with a same component carrier.

Aspect 7: The method of Aspect 5, wherein a third PUSCH, of the one or more PUSCHs, is associated with the second CORESET pool index and at least partially overlaps, in the time domain, with the second PUCCH, and wherein the second UCI is multiplexed on the second PUSCH based at least in part on one of the second PUSCH being associated with a lower component carrier index than the third PUSCH, or the second PUSCH beginning earlier than the third PUSCH and the second PUSCH and the third PUSCH being associated with a same component carrier.

Aspect 8: The method of Aspect 1, wherein a first PUSCH, of the one or more PUSCHs, is associated with the first CORESET pool index and at least partially overlaps, in the time domain, with the first PUCCH, wherein no PUSCHs overlap, in the time domain, with the second PUCCH, wherein the first UCI is multiplexed on the first PUSCH, and wherein the second UCI is transmitted using the second PUCCH.

Aspect 9: The method of Aspect 8, wherein a third PUSCH, of the one or more PUSCHs, is associated with the first CORESET pool index and at least partially overlaps, in the time domain, with the first PUCCH, and wherein the first UCI is multiplexed on the first PUSCH based at least in part on one of the first PUSCH being associated with a lower component carrier index than the third PUSCH, or the first PUSCH beginning earlier than the third PUSCH and the first PUSCH and the third PUSCH being associated with a same component carrier.

Aspect 10: The method of Aspect 1, wherein at least one PUSCH, of the one or more PUSCHs, is associated with the first CORESET pool index and at least partially overlaps, in the time domain, with the first PUCCH, wherein at least one PUSCH, of the one or more PUSCHs, is associated with the first CORESET pool index and at least partially overlaps, in the time domain, with the second PUCCH, and wherein no PUSCHs associated with the second CORESET pool index overlap, in the time domain, with the second PUCCH.

Aspect 11: The method of Aspect 10, wherein communications associated with the PUSCHs associated with the first CORESET pool index are dropped, wherein the first UCI is transmitted using the first PUCCH, and wherein the second UCI is transmitted using the second PUCCH.

Aspect 12: The method of Aspect 11, further comprising receiving a configuration indicating that the PUSCHs associated with the first CORESET pool index should be dropped.

Aspect 13: The method of any of Aspects 11-12, wherein the PUSCHs associated with the first CORESET pool index are dropped based at least in part on the second UCI including a hybrid automatic repeat request acknowledgement message.

Aspect 14: The method of any of Aspects 11-13, wherein the PUSCHs associated with the first CORESET pool index are dropped based at least in part on the PUSCHs associated with the first CORESET pool index being associated with a configured grant PUSCH.

Aspect 15: The method of Aspect 10, wherein the second UCI is dropped, and wherein the first UCI is multiplexed with one of one or more PUSCHs associated with the first CORESET pool index that overlap with the first PUCCH.

Aspect 16: The method of Aspect 15, further comprising receiving a configuration indicating that the second UCI should be dropped.

Aspect 17: The method of any of Aspects 15-16, wherein the second UCI is dropped based at least in part on at least one of: the second UCI includes a periodic or semi-persistent CSI report, or at least one PUSCH, of the one or more PUSCHs, includes an aperiodic CSI report.

Aspect 18: The method of Aspect 10, wherein the UE determines that an error case has occurred.

Aspect 19: The method of Aspect 10, further comprising: identifying at least one PUSCH, of the one or more PUSCHs, that at least partially overlaps, in time domain, with both the first PUCCH and the second PUCCH; and performing the following actions based at least in part on there being one or more remaining PUSCHs associated with the first CORESET pool index and overlapping with the first PUCCH after excluding the at least one PUSCH that at least partially overlaps with both the first PUCCH and the second PUCCH: dropping communications associated with the at least one PUSCH that at least partially overlaps with both the first PUCCH and the second PUCCH; multiplexing the first UCI with a PUSCH among the one or more remaining PUSCHs; and transmitting communications associated with the one or more remaining PUSCHs and the second UCI using the second PUCCH.

Aspect 20: The method of Aspect 19, wherein multiplexing the first UCI with the PUSCH among the one or more remaining PUSCHs further comprises: multiplexing the first UCI with a PUSCH associated with a lowest component carrier index among the one or more remaining PUSCHs; or multiplexing the first UCI with a PUSCH with an earliest starting time based at least in part on the one or more remaining PUSCHs being associated with a same component carrier.

Aspect 21: A method of wireless communication performed by a network entity, comprising: determining that a first PUCCH associated with a UE at least partially overlaps, in a time domain, with a second PUCCH, and that the UE is capable of simultaneous transmission of the first PUCCH and the second PUCCH, wherein the first PUCCH includes a first UCI associated with a first CORESET pool index, the second PUCCH includes a second UCI associated with a second CORESET pool index, and the first PUCCH and the second PUCCH are determined after considering UCI multiplexing procedures for overlapping PUCCHs; and determining that at least one of the first PUCCH or the second PUCCH at least partially overlaps, in the time domain, with one or more PUSCHs; and receiving, from the UE, a communication based at least in part on the determination, wherein the communication includes at least one of the first UCI or the second UCI multiplexed with at least one PUSCH, of the one or more PUSCHs.

Aspect 22: The method of Aspect 21, wherein the first PUCCH and the second PUCCH are associated with a first component carrier.

Aspect 23: The method of Aspect 22, wherein the one or more PUSCHs are associated with the first component carrier.

Aspect 24: The method of Aspect 22, wherein the one or more PUSCHs are associated with a second component carrier different than the first component carrier.

Aspect 25: The method of any of Aspects 21-24, wherein a first PUSCH, of the one or more PUSCHs, is associated with the first CORESET pool index and at least partially overlaps, in the time domain, with the first PUCCH, wherein a second PUSCH, of the one or more PUSCHs, is associated with the second CORESET pool index and at least partially overlaps, in the time domain, with the second PUCCH, wherein the first UCI is multiplexed on the first PUSCH, and wherein the second UCI is multiplexed on the second PUSCH.

Aspect 26: The method of Aspect 25, wherein a third PUSCH, of the one or more PUSCHs, is associated with the first CORESET pool index and at least partially overlaps, in the time domain, with the first PUCCH, and wherein the first UCI is multiplexed on the first PUSCH based at least in part on one of the first PUSCH being associated with a lower component carrier index than the third PUSCH, or the first PUSCH beginning earlier than the third PUSCH and the first PUSCH and the third PUSCH being associated with a same component carrier.

Aspect 27: The method of Aspect 21, wherein a first PUSCH, of the one or more PUSCHs, is associated with the first CORESET pool index and at least partially overlaps, in the time domain, with the first PUCCH, wherein no PUSCHs overlap, in the time domain, with the second PUCCH, and wherein the first UCI is multiplexed on the first PUSCH, and the second UCI is received in the second PUCCH.

Aspect 28: The method of Aspect 27, wherein a third PUSCH, of the one or more PUSCHs, is associated with the first CORESET pool index and at least partially overlaps, in the time domain, with the first PUCCH, and wherein the first UCI is multiplexed on the first PUSCH based at least in part on one of the first PUSCH being associated with a lower component carrier index than the third PUSCH, or the first PUSCH beginning earlier than the third PUSCH and the first PUSCH and the third PUSCH being associated with a same component carrier.

Aspect 29: The method of Aspect 21, wherein at least a first PUSCH, of the one or more PUSCHs, is associated with the first CORESET pool index and at least partially overlaps, in the time domain, with the first PUCCH, wherein at least a second PUSCH, of the one or more PUSCHs, is associated with the first CORESET pool index and at least partially overlaps, in the time domain, with the second PUCCH, and wherein no PUSCHs associated with the second CORESET pool index overlap, in the time domain, with the second PUCCH.

Aspect 30: The method of Aspect 29, wherein the first UCI is multiplexed on one of one or more PUSCHs that overlap with the first UCI.

Aspect 31: The method of Aspect 30, further comprising transmitting, to the UE, a configuration indicating that the second UCI should be dropped.

Aspect 32: The method of Aspect 29, further comprising: identifying at least one PUSCH, of the one or more PUSCHs, that at least partially overlaps, in time domain, with both the first PUCCH and the second PUCCH; and based at least in part on there being one or more remaining PUSCHs associated with the first CORESET pool index and overlapping with the first PUCCH after excluding the at least one PUSCH that at least partially overlaps with both the first PUCCH and the second PUCCH, receiving at least one of: the first UCI in a PUSCH among the one or more remaining PUSCHs, or the second UCI in the second PUCCH.

Aspect 33: The method of Aspect 32, wherein receiving the first UCI in the PUSCH among the one or more remaining PUSCHs further comprises: receiving the first UCI in a PUSCH associated with a lowest component carrier index among the one or more remaining PUSCHs; or receiving the first UCI in a PUSCH with an earliest starting time based at least in part on the one or more remaining PUSCHs being associated with a same component carrier.

Aspect 34: An apparatus for wireless communication at a device, comprising a processor; memory coupled with the processor; and instructions stored in the memory and executable by the processor to cause the apparatus to perform the method of one or more of Aspects 1-20.

Aspect 35: A device for wireless communication, comprising a memory and one or more processors coupled to the memory, the one or more processors configured to perform the method of one or more of Aspects 1-20.

Aspect 36: An apparatus for wireless communication, comprising at least one means for performing the method of one or more of Aspects 1-20.

Aspect 37: A non-transitory computer-readable medium storing code for wireless communication, the code comprising instructions executable by a processor to perform the method of one or more of Aspects 1-20.

Aspect 38: A non-transitory computer-readable medium storing a set of instructions for wireless communication, the set of instructions comprising one or more instructions that, when executed by one or more processors of a device, cause the device to perform the method of one or more of Aspects 1-20.

Aspect 39: An apparatus for wireless communication at a device, comprising a processor; memory coupled with the processor; and instructions stored in the memory and executable by the processor to cause the apparatus to perform the method of one or more of Aspects 21-33.

Aspect 40: A device for wireless communication, comprising a memory and one or more processors coupled to the memory, the one or more processors configured to perform the method of one or more of Aspects 21-33.

Aspect 41: An apparatus for wireless communication, comprising at least one means for performing the method of one or more of Aspects 21-33.

Aspect 42: A non-transitory computer-readable medium storing code for wireless communication, the code comprising instructions executable by a processor to perform the method of one or more of Aspects 21-33.

Aspect 43: A non-transitory computer-readable medium storing a set of instructions for wireless communication, the set of instructions comprising one or more instructions that, when executed by one or more processors of a device, cause the device to perform the method of one or more of Aspects 21-33.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
determine that a first physical uplink control channel (PUCCH) at least partially overlaps, in a time domain, with a second PUCCH, and that the first PUCCH and the second PUCCH can be simultaneously transmitted, wherein
the first PUCCH includes a first uplink control information (UCI) associated with a first control resource set (CORESET) pool index,
the second PUCCH includes a second UCI associated with a second CORESET pool index, and
the first PUCCH and the second PUCCH are determined after performing UCI multiplexing procedures for overlapping PUCCHs; and
determine that at least one of the first PUCCH or the second PUCCH at least partially overlaps, in the time domain, with one or more physical uplink shared channels (PUSCHs); and
transmit communications using less than all of the first PUCCH, the second PUCCH, and the one or more PUSCHs based at least in part on at least one of:
multiplex at least one of the first UCI or the second UCI with at least one PUSCH, of the one or more PUSCHs, or
drop communications associated with at least one of the first PUCCH, the second PUCCH, or the one or more PUSCHs.

2. The apparatus of claim 1, wherein the first PUCCH and the second PUCCH are associated with a first component carrier.

3. The apparatus of claim 2, wherein the one or more PUSCHs are associated with the first component carrier.

4. The apparatus of claim 2, wherein the one or more PUSCHs are associated with a second component carrier different than the first component carrier.

5. The apparatus of claim 1, wherein a first PUSCH, of the one or more PUSCHs, is associated with the first CORESET pool index and at least partially overlaps, in the time domain, with the first PUCCH, wherein a second PUSCH, of the one or more PUSCHs, is associated with the second CORESET pool index and at least partially overlaps, in the time domain, with the second PUCCH, wherein the first UCI is multiplexed on the first PUSCH, and wherein the second UCI is multiplexed on the second PUSCH.

6. The apparatus of claim 5, wherein a third PUSCH, of the one or more PUSCHs, is associated with the first CORESET pool index and at least partially overlaps, in the time domain, with the first PUCCH, and wherein the first UCI is multiplexed on the first PUSCH based at least in part on one of the first PUSCH being associated with a lower component carrier index than the third PUSCH, or the first PUSCH beginning earlier than the third PUSCH and the first PUSCH and the third PUSCH being associated with a same component carrier.

7. The apparatus of claim 5, wherein a third PUSCH, of the one or more PUSCHs, is associated with the second CORESET pool index and at least partially overlaps, in the time domain, with the second PUCCH, and wherein the second UCI is multiplexed on the second PUSCH based at least in part on one of the second PUSCH being associated with a lower component carrier index than the third PUSCH, or the second PUSCH beginning earlier than the third PUSCH and the second PUSCH and the third PUSCH being associated with a same component carrier.

8. The apparatus of claim 1, wherein a first PUSCH, of the one or more PUSCHs, is associated with the first CORESET pool index and at least partially overlaps, in the time domain, with the first PUCCH, wherein no PUSCHs overlap, in the time domain, with the second PUCCH, wherein the first UCI is multiplexed on the first PUSCH, and wherein the second UCI is transmitted using the second PUCCH.

9. The apparatus of claim 8, wherein a third PUSCH, of the one or more PUSCHs, is associated with the first CORESET pool index and at least partially overlaps, in the time domain, with the first PUCCH, and wherein the first UCI is multiplexed on the first PUSCH based at least in part on one of the first PUSCH being associated with a lower component carrier index than the third PUSCH, or the first PUSCH beginning earlier than the third PUSCH and the first PUSCH and the third PUSCH being associated with a same component carrier.

10. The apparatus of claim 1, wherein at least a first PUSCH, of the one or more PUSCHs, is associated with the first CORESET pool index and at least partially overlaps, in the time domain, with the first PUCCH, wherein at least a second PUSCH, of the one or more PUSCHs, is associated with the first CORESET pool index and at least partially overlaps, in the time domain, with the second PUCCH, and wherein no PUSCHs associated with the second CORESET pool index overlap, in the time domain, with the second PUCCH.

11. The apparatus of claim 10, wherein communications associated with the PUSCHs associated with the first CORESET pool index are dropped, wherein the first UCI is transmitted using the first PUCCH, and wherein the second UCI is transmitted using the second PUCCH.

12. The apparatus of claim 11, wherein the one or more processors are further configured to receive a configuration indicating that the PUSCHs associated with the first CORESET pool index should be dropped.

13. The apparatus of claim 11, wherein the PUSCHs associated with the first CORESET pool index are dropped based at least in part on the second UCI including a hybrid automatic repeat request acknowledgement message.

14. The apparatus of claim 11, wherein the PUSCHs associated with the first CORESET pool index are dropped based at least in part on the PUSCHs associated with the first CORESET pool index being associated with a configured grant PUSCH.

15. The apparatus of claim 10, wherein the second UCI is dropped, and wherein the first UCI is multiplexed with one of one or more PUSCHs associated with the first CORESET pool index that overlap with the first PUCCH.

16. The apparatus of claim 15, wherein the one or more processors are further configured to receive a configuration indicating that the second UCI should be dropped.

17. The apparatus of claim 15, wherein the second UCI is dropped based at least in part on at least one of:
the second UCI includes a periodic or semi-persistent channel state information (CSI) report, or
at least one PUSCH, of the one or more PUSCHs, includes an aperiodic CSI report.

18. The apparatus of claim 10, wherein the UE determines that an error case has occurred.

19. The apparatus of claim 10, wherein the one or more processors are further configured to:
identify at least one PUSCH, of the one or more PUSCHs, that at least partially overlaps, in time domain, with both the first PUCCH and the second PUCCH; and
perform the following actions based at least in part on there being one or more remaining PUSCHs associated with the first CORESET pool index and overlapping with the first PUCCH after excluding the at least one PUSCH that at least partially overlaps with both the first PUCCH and the second PUCCH:
drop communications associated with the at least one PUSCH that at least partially overlaps with both the first PUCCH and the second PUCCH;
multiplex the first UCI with a PUSCH among the one or more remaining PUSCHs; and
transmit communications associated with the one or more remaining PUSCHs and the second UCI using the second PUCCH.

20. The UE of claim 19, wherein multiplexing the first UCI with the PUSCH among the one or more remaining PUSCHs further comprises:
multiplexing the first UCI with a PUSCH associated with a lowest component carrier index among the one or more remaining PUSCHs; or
multiplexing the first UCI with a PUSCH with an earliest starting time based at least in part on the one or more remaining PUSCHs being associated with a same component carrier.

21. An apparatus for wireless communication at a network entity, comprising:
a memory; and
one or more processors, coupled to the memory, configured to:
determine that a first physical uplink control channel (PUCCH) associated with a user equipment (UE) at least partially overlaps, in a time domain, with a second PUCCH, and that the UE is capable of simultaneous transmission of the first PUCCH and the second PUCCH, wherein
the first PUCCH includes a first uplink control information (UCI) associated with a first control resource set (CORESET) pool index,
the second PUCCH includes a second UCI associated with a second CORESET pool index, and
the first PUCCH and the second PUCCH are determined after considering UCI multiplexing procedures for overlapping PUCCHs; and
determine that at least one of the first PUCCH or the second PUCCH at least partially overlaps, in the time domain, with one or more physical uplink shared channels (PUSCHs); and
receive, from the UE, a communication based at least in part on the determination, wherein the communication includes at least one of the first UCI or the second UCI multiplexed with at least one PUSCH, of the one or more PUSCHs.

22. The apparatus of claim 21, wherein a first PUSCH, of the one or more PUSCHs, is associated with the first CORESET pool index and at least partially overlaps, in the time domain, with the first PUCCH, wherein a second PUSCH, of the one or more PUSCHs, is associated with the second CORESET pool index and at least partially overlaps, in the time domain, with the second PUCCH, wherein the first UCI is multiplexed on the first PUSCH, and wherein the second UCI is multiplexed on the second PUSCH.

23. The apparatus of claim 21, wherein a first PUSCH, of the one or more PUSCHs, is associated with the first CORESET pool index and at least partially overlaps, in the time domain, with the first PUCCH, wherein no PUSCHs overlap, in the time domain, with the second PUCCH, wherein the first UCI is multiplexed on the first PUSCH, and the second UCI is received in the second PUCCH.

24. The apparatus of claim 21, wherein at least a first PUSCH, of the one or more PUSCHs, is associated with the first CORESET pool index and at least partially overlaps, in the time domain, with the first PUCCH, wherein at least a second PUSCH, of the one or more PUSCHs, is associated with the first CORESET pool index and at least partially overlaps, in the time domain, with the second PUCCH, and wherein no PUSCHs associated with the second CORESET pool index overlap, in the time domain, with the second PUCCH.

25. The apparatus of claim 24, wherein the first UCI is multiplexed on one of one or more PUSCHs that overlap with the first UCI.

26. The apparatus of claim 25, wherein the one or more processors are further configured to transmit, to the UE, a configuration indicating that the second UCI should be dropped.

27. The apparatus of claim 24, wherein the one or more processors are further configured to:
identify at least one PUSCH, of the one or more PUSCHs, that at least partially overlaps, in time domain, with both the first PUCCH and the second PUCCH; and
receive, based at least in part on there being one or more remaining PUSCHs associated with the first CORESET pool index and overlapping with the first PUCCH after excluding the at least one PUSCH that at least partially overlaps with both the first PUCCH and the second PUCCH, at least one of:
the first UCI in a PUSCH among the one or more remaining PUSCHs, or
the second UCI in the second PUCCH.

28. A method of wireless communication performed by a user equipment (UE), comprising:
determining that a first physical uplink control channel (PUCCH) at least partially overlaps, in a time domain, with a second PUCCH, and that the first PUCCH and the second PUCCH can be simultaneously transmitted, wherein
the first PUCCH includes a first uplink control information (UCI) associated with a first control resource set (CORESET) pool index,
the second PUCCH includes a second UCI associated with a second CORESET pool index, and
the first PUCCH and the second PUCCH are determined after performing UCI multiplexing procedures for overlapping PUCCHs; and
determining that at least one of the first PUCCH or the second PUCCH at least partially overlaps, in the time domain, with one or more physical uplink shared channels (PUSCHs); and
transmitting communications using less than all of the first PUCCH, the second PUCCH, and the one or more PUSCHs based at least in part on at least one of:
multiplexing at least one of the first UCI or the second UCI with at least one PUSCH, of the one or more PUSCHs, or
dropping communications associated with at least one of the first PUCCH, the second PUCCH, or the one or more PUSCHs.

29. The method of claim 28, wherein a first PUSCH, of the one or more PUSCHs, is associated with the first CORESET pool index and at least partially overlaps, in the time domain, with the first PUCCH, wherein a second PUSCH, of the one or more PUSCHs, is associated with the second CORESET pool index and at least partially overlaps, in the time domain, with the second PUCCH, wherein the first UCI is multiplexed on the first PUSCH, and wherein the second UCI is multiplexed on the second PUSCH.

30. The method of claim 28, wherein a first PUSCH, of the one or more PUSCHs, is associated with the first CORESET pool index and at least partially overlaps, in the time domain, with the first PUCCH, wherein no PUSCHs overlap, in the time domain, with the second PUCCH, wherein the first UCI is multiplexed on the first PUSCH, and wherein the second UCI is transmitted using the second PUCCH.

31. The method of claim 28, wherein at least one PUSCH, of the one or more PUSCHs, is associated with the first CORESET pool index and at least partially overlaps, in the time domain, with the first PUCCH, wherein at least one PUSCH, of the one or more PUSCHs, is associated with the first CORESET pool index and at least partially overlaps, in the time domain, with the second PUCCH, and wherein no PUSCHs associated with the second CORESET pool index overlap, in the time domain, with the second PUCCH.

32. A method of wireless communication performed by a network entity, comprising:
determining that a first physical uplink control channel (PUCCH) associated with a user equipment (UE) at least partially overlaps, in a time domain, with a second PUCCH, and that the UE is capable of simultaneous transmission of the first PUCCH and the second PUCCH, wherein
the first PUCCH includes a first uplink control information (UCI) associated with a first control resource set (CORESET) pool index,
the second PUCCH includes a second UCI associated with a second CORESET pool index, and
the first PUCCH and the second PUCCH are determined after considering UCI multiplexing procedures for overlapping PUCCHs; and
determining that at least one of the first PUCCH or the second PUCCH at least partially overlaps, in the time domain, with one or more physical uplink shared channels (PUSCHs); and
receiving, from the UE, a communication based at least in part on the determination, wherein the communication includes at least one of the first UCI or the second UCI multiplexed with at least one PUSCH, of the one or more PUSCHs.

33. The method of claim 32, wherein a first PUSCH, of the one or more PUSCHs, is associated with the first CORESET pool index and at least partially overlaps, in the time domain, with the first PUCCH, wherein a second PUSCH, of the one or more PUSCHs, is associated with the second CORESET pool index and at least partially overlaps, in the time domain, with the second PUCCH, wherein the first UCI is multiplexed on the first PUSCH, and wherein the second UCI is multiplexed on the second PUSCH.

34. A non-transitory computer-readable medium storing a set of instructions for wireless communication, the set of instructions comprising:
one or more instructions that, when executed by one or more processors of a user equipment (UE), cause the UE to:
determine that a first physical uplink control channel (PUCCH) at least partially overlaps, in a time domain, with a second PUCCH, and that the first PUCCH and the second PUCCH can be simultaneously transmitted, wherein
the first PUCCH includes a first uplink control information (UCI) associated with a first control resource set (CORESET) pool index,
the second PUCCH includes a second UCI associated with a second CORESET pool index, and
the first PUCCH and the second PUCCH are determined after performing UCI multiplexing procedures for overlapping PUCCHs; and
determine that at least one of the first PUCCH or the second PUCCH at least partially overlaps, in the time domain, with one or more physical uplink shared channels (PUSCHs); and
transmit communications using less than all of the first PUCCH, the second PUCCH, and the one or more PUSCHs based at least in part on at least one of:
multiplex at least one of the first UCI or the second UCI with at least one PUSCH, of the one or more PUSCHs, or
drop communications associated with at least one of the first PUCCH, the second PUCCH, or the one or more PUSCHs.

35. The non-transitory computer-readable medium of claim 34, wherein a first PUSCH, of the one or more PUSCHs, is associated with the first CORESET pool index and at least partially overlaps, in the time domain, with the first PUCCH, wherein no PUSCHs overlap, in the time domain, with the second PUCCH, wherein the first UCI is multiplexed on the first PUSCH, and wherein the second UCI is transmitted using the second PUCCH.
